(19) United States
(12) Patent Application Publication
(10) Pub. No.: US 2003/0236995 A1
(43) Pub. Date: Dec. 25, 2003

(54) Method and apparatus for facilitating detection of network intrusion

(76) Inventor: Lyman Jefferson Fretwell JR., Randolph, NJ (US)

Correspondence Address: STEVEN B. PHILLIPS, MOORE & VAN ALLEN, 2200 WEST MAIN STREET, SUITE 800, DURHAM, NC, 27705, US

(21) Appl. No.: 10/177,078

(22) Filed: Jun. 21, 2002

(51) Int. Cl. G06F 11/30

(52) U.S. Cl. 713/200

(57) ABSTRACT

System for facilitating detection of network intrusion. Through continuous accumulation of network traffic parameter information, data for a particular session is reduced to a single metric that represents the threat potential of the session as compared to normal network traffic. An analysis station accumulates and maintains the historical data and defines a point for each specific session within a distribution. The dimensions in the distribution space take into account various network traffic parameters useful in identifying an attack. The distance between a session's point and the centroid of the distribution represents the threat metric. The analysis station can display the threat metric as a point or points on a display. The intensity of the point is an indication of the threat potential. The easy-to-read display calls anomalous traffic to the attention of an operator and facilitates discrimination among ambiguous cases.

### BACKGROUND

The wide proliferation of computer networks and the use of those networks and the Internet to manage critical information throughout industry and government have made computer network security a key area of technological research and development in recent years. Commercially available products for network surveillance or intrusion detection tend to operate in a trip-wire mode. They attempt to maintain a current catalog of preprogrammed “traps” to snare known attacks. Specific, fixed rules and detection thresholds are used. Data visualization and analysis tools generally are limited due to the two-dimensional nature of conventional workstation displays. In addition, many systems are firewall-based and cannot detect the threats generated internally to the network. Many experts consider internal tampering to be the greatest threat to today's network security, since recent events have highlighted the vulnerability of physical premises to infiltration.

Many current systems also suffer from a high rate of false alarms, and less than exemplary detection probabilities. Example rates for commercial network security systems for enterprise networks are 35-85% detection probability with approximately ten false alarms per day. Less than optimum detection probabilities and high rates of false alarms result in extensive operator supervision and a reduction in the efficiency of the network. While it may be impossible to completely eliminate false alarms, at least without operator intervention, it would be desirable for an operator to have an accurate picture of the threat potential of traffic on the network. Therefore, operator time could be spent investigating network sessions which are truly likely to represent a malicious attack on the network.

### SUMMARY

The present invention provides for an efficient, accurate, monitoring and analysis system to facilitate intrusion detection in a packet network. By continuously analyzing and storing data corresponding to a plurality of network traffic parameters, the system can reduce the data for any particular session to a single threat metric that represents the threat potential of the session as compared to normal traffic. The threat metric takes into account a variety of traffic parameters useful in detecting threat scenarios, including parameters related to packet violations and handshake sequence. For some of the traffic parameters, moments are used to characterize the parameters, resulting in a reduction in the amount of data that must be analyzed and stored. The ability to represent the threat with a single metric for each session at any particular time facilitates plotting network traffic threat potentials on an easy-to-read display.

In at least some embodiments of the invention, the process of producing a threat metric for a session begins with accumulating historical data when a threat is not present corresponding to at least some of a plurality of internet protocol (IP) traffic parameters that are being used to characterize threat potential. The plurality of traffic parameters is then measured for the specific session in question. The parameters are then used to produce a plurality of summary parameters characterizing the plurality of traffic parameters. At least some of these summary parameters are scaled using the historical data to produce component metrics which define a point corresponding to the specific session in a multi-dimensional space containing a distribution of points corresponding to current sessions. Each dimension in the space corresponds to one of the component metrics. The distance of the point representing the particular session from the centroid of the distribution represents the threat metric.

The method of the invention in some embodiments is carried out in a network by one or more data capture stations and one or more analysis stations. Each data capture station acts as a monitoring agent. Each is implemented in at least some embodiments by a general purpose workstation or personal computer system, also referred to herein as an “instruction execution system” running a computer program product containing computer program instructions. Each data capture station has a network interface operating in promiscuous mode for capturing packets associated with the plurality of current sessions on the network. The monitoring agent produces summary parameters from measured network traffic parameters. These summary parameters include central moments for time and inverse time between packets, and may include a numerical value assigned to specific packet violations, nonlinear generalizations of one or more rates, and one or more rates computed against numbers of packets as opposed to against time. These summary parameters are regularly forwarded from a second network interface in the data capture station through the same or a parallel network and to the analysis station. The summary parameters represent a relatively small amount of data and so do not present a significant drain on network resources.

The analysis station in at least some embodiments accumulates and maintains the historical data, scales at least some of the summary parameters for a particular session using the historical data, and produces component metrics for each specific session. The component metrics are used as dimensions to define a point for each specific session in the multidimensional space. In some cases, summary parameters are further reduced or processed by the analysis station before being scaled, producing other, intermediate summary parameters. It is the act of scaling summary parameters using the historical data that transforms a general elliptical distribution into a spherical or similar distribution of points for current sessions. Thus a single numerical metric (the distance of each session's point from the centroid) can be used as the threat metric, which is an indication of threat potential. The analysis station, in some embodiments, then displays the threat metric as a point or points on a display, the intensity of which (in gray level) is an indication of the threat potential for a particular session at a particular time. In some embodiments, provisions are made to expand the display on command to provide more information to the operator, and to highlight points, for example with a color shadow, when the threat metric exceeds a specific, pre-determined threshold or thresholds. Provisions can be made for handling both one-to-one sessions (one server address and one client address) or one-to-many sessions between a client address and multiple server addresses or a server address and multiple apparent client addresses. In any case, the easy-to-read display calls anomalous traffic to the attention of an operator and facilitates discrimination among ambiguous cases.

### BRIEF DESCRIPTION OF THE DRAWINGS

FIG. 1 is a block diagram that illustrates the flow of data between various component processes of one embodiment of the invention, for the portion of the overall method of the invention that is related to scaling and otherwise processing summary parameters to produce component metrics. FIG. 1 is presented as FIGS. 1A and 1B for viewing clarity.

FIG. 2 illustrates a distribution of session points in multi-dimensional space according to at least some embodiments of the invention and illustrates the deviation of an anomalous session from the centroid of the normal sessions.

FIG. 3 is a flowchart that illustrates the overall method of some embodiments of the invention.

FIG. 4 is a flow diagram that illustrates how new packets are associated with particular sessions in at least some embodiments of the invention. FIG. 4 is presented as FIGS. 4A and 4B for clarity.

FIG. 5 is a flow diagram that illustrates how a summary parameter is assigned to a packet violation in at least some embodiments of the invention. FIG. 5 is presented as FIGS. 5A and 5B for clarity.

FIG. 6 is a conceptual diagram that illustrates how the IP protocol handshake procedure is generalized in order to enable a summary parameter to be assigned to handshake violations in implementing the invention.

FIG. 7 is a flow diagram that illustrates how a summary parameter is assigned to an outgoing packet handshake according to at least some embodiments of the invention. FIG. 7 is presented as FIGS. 7A and 7B for clarity.

FIG. 8 is a screen shot of a gram-metric display that can be used with the present invention.

FIG. 9 is a flowchart that illustrates a method of displaying a particular threat metric on the gram-metric display of FIG. 8.

FIG. 10 is a conceptual illustration of a display element that is used to dynamically adjust display thresholds and contrast according to at least some embodiments of the invention.

FIG. 11 is a flow diagram that illustrates how certain, known network threats can be categorized based on observed metric components according to some embodiments of the invention.

FIG. 12 is a network block diagram that illustrates one possible operating environment and network architecture of the invention.

FIG. 13 is a timing diagram that illustrates how two or more monitoring agents seeing the same packet interact in the network of FIG. 12 to establish which packets correspond to one another, and to establish time synchronization between the monitoring agents.

FIG. 14 is a block diagram of a personal computer or workstation that is implementing some portion of the invention in at least some embodiments.

FIG. 15 is a block diagram that illustrates the flow of data when summary parameters are created and scaled for the case of one-to-many sessions which are composed of multiple subsessions.

### DETAILED DESCRIPTION OF ONE OR MORE EMBODIMENTS

The present invention can most readily be understood by considering the detailed embodiments presented herein. These embodiments are presented in the context of an IP network using primarily transmission control protocol (TCP), although the invention also uses other protocols (such as UDP, ICMP and HTML) at any layer. The concept of characterizing network traffic with a plurality of measured parameters, plotting session points in multidimensional space, and measuring the threat potential by a distance of a particular session's point from the centroid of the distribution can apply equally well to any type of network. It should be noted that since the embodiments are described with reference to IP networks, standard IP terminology is used. This terminology, including some acronyms, is well known to those of ordinary skill in the art, and so sometimes may not be explained in detail. However, it is helpful to the reader to discuss other terminology used herein. In most cases terms are discussed, if needed, when they are first introduced.

Some terms used throughout this description should be understood from the beginning. A “client” is defined herein to be the originator of a session on the network. A “server” is defined as the target of a session, even though the target might be another personal computer or workstation that normally serves as a client. Outgoing packets are those going from client to server, incoming packets are those going from server to client.

The terms, “network traffic parameters”, “traffic parameters”, “measured parameter”, and in some cases, simply “parameters” are meant to refer to the characteristics of packets on the network that are measured. For example, times, rates, etc. These terms are meant in their broadest sense in that a parameter need not be a continuously variable number. It may simply be, for example, whether or not a packet meets or fails to meet a certain criteria such as the existence of a packet header consistency violation, subsequently referred to herein as a packet violation. Of course the term “measuring” is meant broadly as well, and can refer to measuring in the traditional sense, or simply to looking at the contents of a packet and making a simple determination. “Summary parameters” and metrics may be dimensionless quantities in the sense that they have no specific units. Component metrics are used to determine the single threat metric, which is indicative of the threat likelihood a specific session represents. Component metrics and/or summary parameters may be directly related to traffic parameters, but in any case, component metrics characterize summary parameters and summary parameter characterize traffic parameters. In some cases, such as for packet violations, a summary parameter is determined by simply assigning a numerical value. Summary parameters may or may not need to be scaled in order to be used as a component metric for plotting session points—it depends on the traffic parameter involved. Historical data corresponding to traffic parameters is any data consisting of or related to traffic parameters over time. It can be kept in the form of the summary parameters, component metrics, or in the form of the traffic parameters and units or in some other form, although typically it will be more efficient to keep it in the form of summary parameters. Historical data might not be kept on all traffic parameters.

Finally, the term session, even standing alone, can refer to a typical, one-to-one, client/server communication session. However, it can also refer to sessions which involve multiple subsessions. It may be the case that with typical Internet usage that a new session starts between two addresses before the old session is closed. In this case, such a session is treated in some instances as a session with multiple subsessions. However, a session can also have multiple subsessions if multiple clients access one server in some related fashion or one client attempts to access multiple servers, as in an IP address scan. In the latter case, traffic between the single client or server and one of the other addresses is characterized as a “subsession.” In this latter case, the main session might be referred to as a “supersession” or a “one-to-many” session. The meanings of these terms will become clearer when the derivation of component metrics is discussed in detail later.

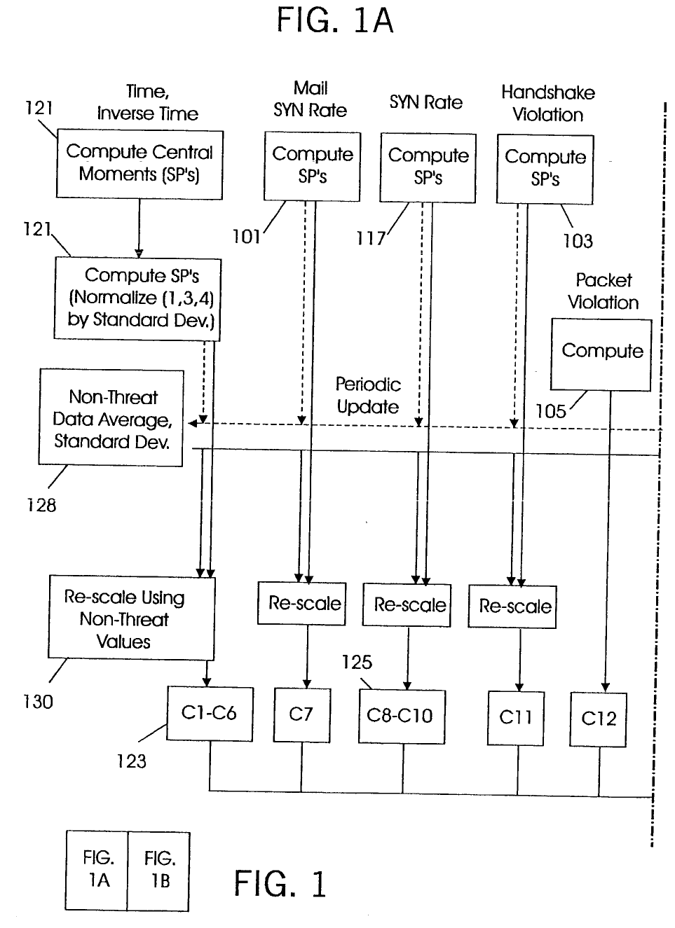

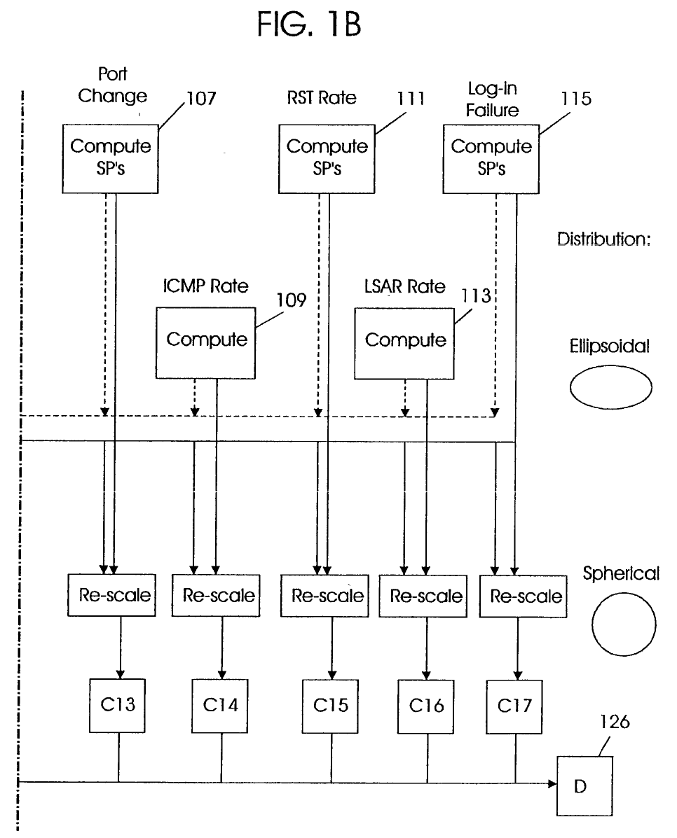

FIG. 1 describes the portion of the invention related to computing and scaling values to determining component metric values to be used in plotting a session point and determining a distance to produce the threat metric. FIG. 1 is presented in two parts, as FIGS. 1A and 1B. While a practical implementation of the invention in most embodiments will include other processes as described herein, the various processes and elements of the invention are easier to understand if one first has an understanding of the basic algorithm illustrated in FIG. 1. The various blocks indicate processes or steps acting on particular inputs and outputs, usually implemented as software. Individual summary parameters (SP's) are computed at steps 101, 103, 105, 107, 109, 111, 113, and 115, from the indicated traffic parameters. At step 117, three summary parameters are computed from one traffic parameter, the rate of SYN packets in the session. At 119, six summary parameters are computed from an original eight summary parameters. The initial eight summary parameters are computed from central moments of just two traffic parameters, the average time between packets, and the inverse average time between packets. The original eight summary parameters, including the central moments, are computed at step 121.

Thus, the component metrics for the embodiment illustrated in FIG. 1 can be used as dimensional values (shown as “C” numbers FIG. 1) to define or conceptually plot a point in a 17-dimensional metric space, where each dimension corresponds to one of the component metrics as follows:

First, third and fourth moments of time and inverse time between packets (second moment is used for normalization). Timing between successive packets in an attack or probe often differs from timing in normal network traffic. These form dimensions C1-C6, shown at 123 of FIG. 1

Rate of synchronization/start (SYN) packets to a mail-related destination port. Denial-of-service (DOS) attacks on a mail server utilize multiple mail messages sent at a high data rate. This metric defines the single dimension C7.

Rate of all SYN packets, SYN rate divided by average packet size, and SYN rate over packet size over standard deviation of time between SYN packets. In a SYN DOS attack, SYN packets are sent at a high rate, the packet size is minimal, and they are usually uniformly spaced in time. Since these parameters are all related to SYN rate, they are grouped together and define dimensions C8-C10 shown at 125 of FIG. 1.

Rate of handshake violations observed. DOS attacks and probes often utilize components of the TCP handshake sequence (SYN, SYN ACK, ACK, FIN) but in sequences that violate the TCP handshake protocol sequence. This metric defines dimension C11 in FIG. 1, and will be discussed in more detail later.

Packet violation. There are illegal packet structures (such as same IP address for source and destination, as in a known type of attack called a Land attack) where one occurrence indicates anomalous activity that should raise an alarm. The value returned when the metric is computed indicates which particular anomaly was discovered, and no re-scaling is performed. Instead this metric directly serves as dimension C12.

Rate of change of destination port. Initial probes of a potential target often look for which ports are open, indicating which functions the machine performs as well as which ports may be used to attack the machine. Keeping track of all ports accessed in a session would require prohibitively large amounts of storage and processing. The algorithm in the present embodiment of the invention monitors the rate at which the destination port changes, a much more efficient measure of the same effect. This metric is used to create dimension C13.

Internet control message protocol (ICMP) ping rate. ICMP pings may be associated with an attack. Normal users may occasionally use ICMP pings. The process illustrated in FIG. 1 looks for higher rates of ICMP pings and uses a metric related to this parameter to form dimension C14.

Reset (RST) rate. Handshake violations sometimes cause the target machine to issue an RST packet. An attacker may issue an RST packet to interrupt initiation of a handshake sequence. Because RST packets also occur in normal traffic, higher rates of RST packets in a session are indicative of a potential problem, and this metric is used to form dimension C15.

Local security architecture remote procedure call (LSARPC or LSAR) packet rate. Higher rates of LSARPC packets indicate a known type of attack referred to as an NTInfoscan attack. This rate is used to for dimension C16 in FIG. 1.

Log-in failure. Repeated log-in failures (E-mail, Telnet) are likely to indicate someone attempting unauthorized access. Valid failures will occur due to typing errors. A number of failures above a threshold is viewed as a threat and the metric for this parameter forms dimension C17.

FIG. 1 illustrates how the component metrics are combined into the single threat metric. Distance D of a point in the 17-dimensional space defines the threat metric. For all parameters except packet violation, mean and standard deviation are computed during normal (non-attack) network operation to accumulate historical data, which characterize non-threat data at 128 in FIG. 1. Time periods where the metric distance exceeds a threshold for any session may indicate the presence of an attack and are not included in this averaging process. Separate averages are computed hourly for time of day and day of the week. Alternatively, they may be grouped together (9:00 to 5:00, Monday through Friday, for example). Holidays are assumed to be equivalent to weekend time. For each session, this “normal” mean is subtracted from the observed metric component value and the result is divided by the “normal” standard deviation. This in effect re-scales the data at 130 (except for packet violation) to convert what would have been an ellipsoidal distribution into a spherical distribution, so that each metric component has equal weight. The packet violation component is different in that a single occurrence indicates a violation. Thus, packet violations are assigned a large number, in a manner to be described in detail below. It cannot be overemphasized that not all summary parameters are scaled, and the amount of processing of summary parameters prior to any scaling varies. Sometimes intermediate summary parameters may result, as is the case with the first six component metrics. This will also be the case in handling one-to-many sessions, discussed later. Also, some component metrics are determined or produced by simply assigning a summary parameter value to the component metric when no scaling is needed, as in the case of packet violations. In such a case, the summary parameter and the component metric are in fact the same.

Some of these “rates” are computed differently from traditional rates in order to ameliorate artifacts due to burstiness often seen near session startup or to emphasize particular dependencies. In addition, some rates are actually rates per number of packets observed rather than per unit time. Computing rates in this way prevents an attacker from tricking the system by slowing down the traffic to try and “fool” network monitoring algorithms. Additionally, some summary parameters comprise what are referred to herein as “nonlinear generalizations of rates.” In such cases, the summary parameters are based on squares or higher powers of rate information. These can be used alone or mixed with normal rates. These nonlinear generalizations have the effect of exaggerating small differences in rates so that attacks based mostly on the corresponding network parameters are more easily distinguished from normal traffic. A listing of input data and equations used in an example embodiment of the invention with comments is listed at the end of the specification for reference. The listing at the end of the specification includes all the equations used in the example embodiments described herein. It should be noted that although 17 component metrics are shown, the invention may produce satisfactory results in some cases with fewer metrics. Even one or two metrics can be used if chosen properly—with the understanding that the results might only be meaningful for specific types of threats. A prototype system with seven component metrics has been found to provide generally useful results. Also, additional traffic parameters and related summary parameters and component metrics could be added if needed, resulting in even more dimensions in the distribution space.

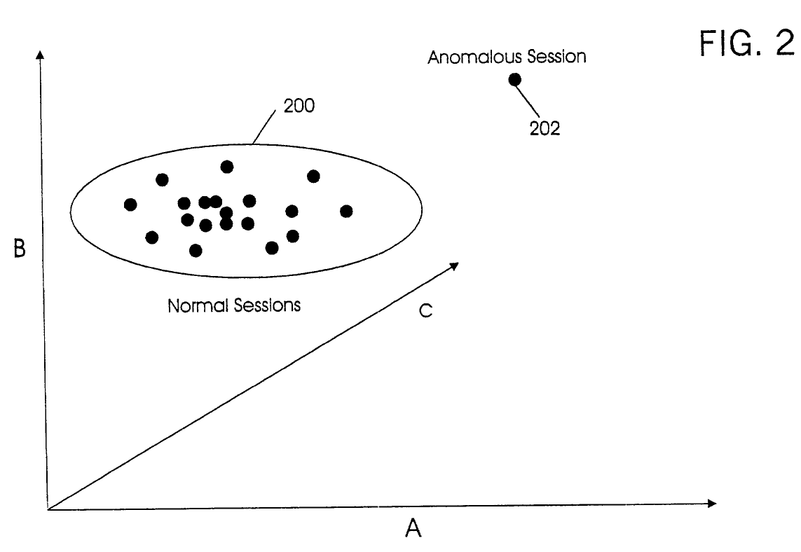

FIG. 2 is a conceptual illustration to show how the plotted points for the various current sessions can help identify an anomalous session. For clarity, only three dimensions are shown in FIGS. 2, A, B, and C. In the case of the embodiment of the invention described herein, the plot would have 17 dimensions. Since each session, or data exchange between specific addresses, on the network is analyzed separately, normal data clusters in the spherical distribution 200, which appears oval due to the perspective view. An anomalous and possibly threatening session, 202, will appear as a point well removed from the distribution of points representing current sessions. Because of the spherical distribution, a single threat metric value characterizes each session and is determined by the distance of the session's point from the centroid or center point of the distribution. Since the normal data used for scaling some of the component metrics is collected and analyzed on an ongoing basis, the system can adapt to evolutionary changes in network traffic.

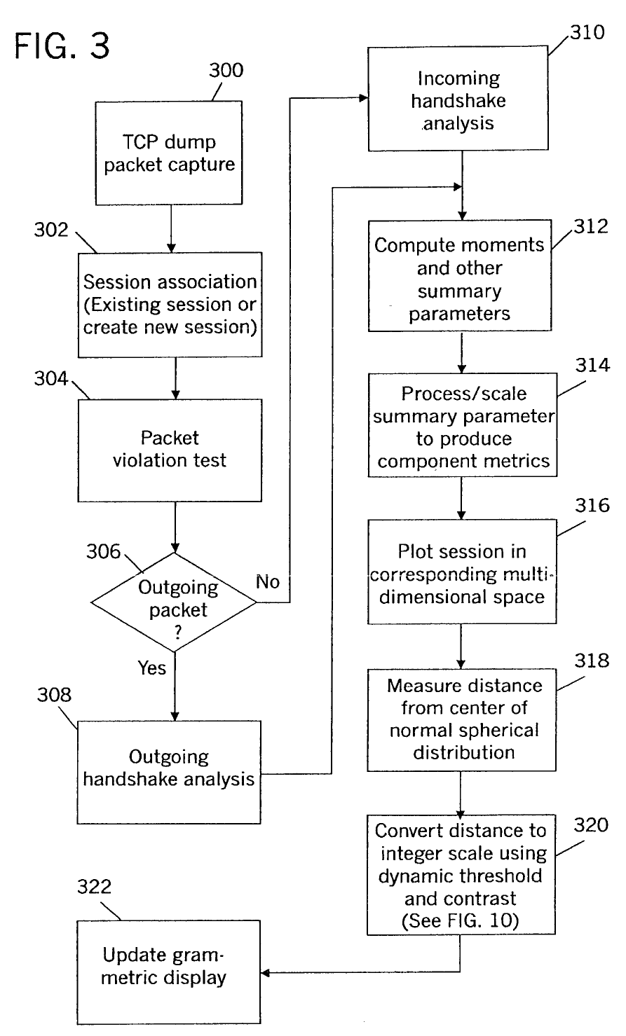

With an understanding of the basic concept behind the scaling and measuring processes of the invention, it is straightforward to produce an embodiment that, in practical application, provides a useful system for threat determination and analysis. FIG. 3 is a flowchart illustrating the overall operation of such a system. The flowchart represents one iteration of updating a sessions data when a packet is captured. This process would continuously repeat for each session while a system according to the invention was in operation. At step 300 a packet is captured via TCP dump. Typically, a workstation is capturing packets on a network interface card operating in promiscuous mode. The packet is analyzed at 302 to determine if it represents a new session, or if it belongs to an existing session. In either case, it is associated with an appropriate session, either existing or newly created. At 304, the packet violation test is performed. A summary parameter, which is also the component metric, is assigned immediately and set as the appropriate dimension if there is a packet violation, since packet violations are not scaled. At 306, a determination is made as to whether the packet is an outgoing packet. If so, an outgoing handshake analysis is performed at 308. If not, an incoming handshake analysis is performed at 310. These two analyses are slightly different, and will be discussed in detail below. It should be noted that step 306 could have been framed in terms of whether the packet was an incoming packet.

Appropriate summary parameters are computed at step 312. In the case of the time and inverse time between packets, these summary parameters include the central moments as previously described. At step 314 summary parameters are further processed and/or scaled as needed. The updated current session values are plotted again in an updated plot at step 316. The distance from the centroid of the distribution is determined at step 318.

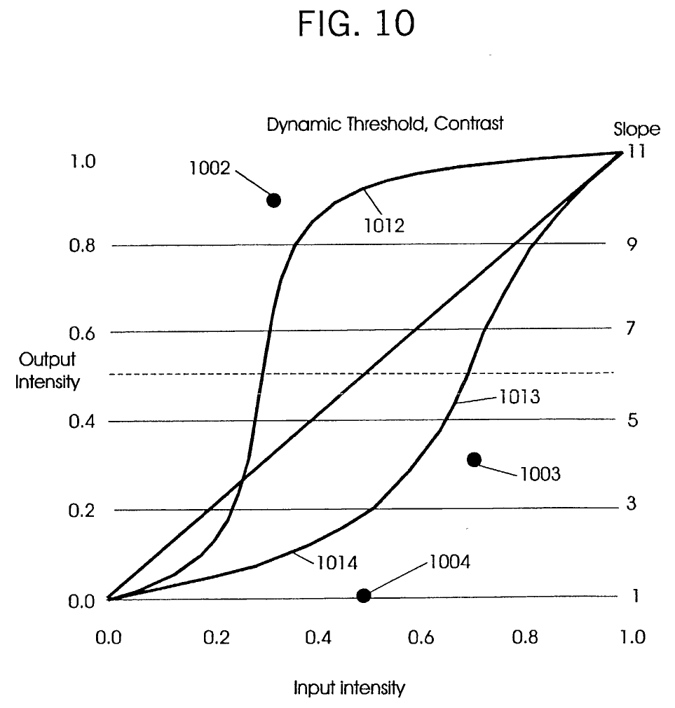

The last two steps in the flowchart of FIG. 3 are related to displaying the data on the monitor of an analysis station that is being used to implement the invention. Plotting the threat metric can often most easily be accomplished by converting the distance to an integer scale, as shown at step 320, for example, to any one of 256 or fewer integers on an integer scale where the higher the number, the greater the distance and hence the threat. In some embodiments this involves taking the logarithm of the distance threat metric as will be discussed later. Dynamic threshold and contrast as discussed in relation to FIG. 10 in this disclosure can be used. This integer value can then be plotted directly on a display at 322, for example, by mapping the value into one of 256 or fewer possible shades of gray on a gram-metric display. A gram-metric display will be described in more detail later, but it is essentially a way to display multiple dimensions on a two dimensional space, where one dimension, in the present case, time, is continuously scrolling up the screen.

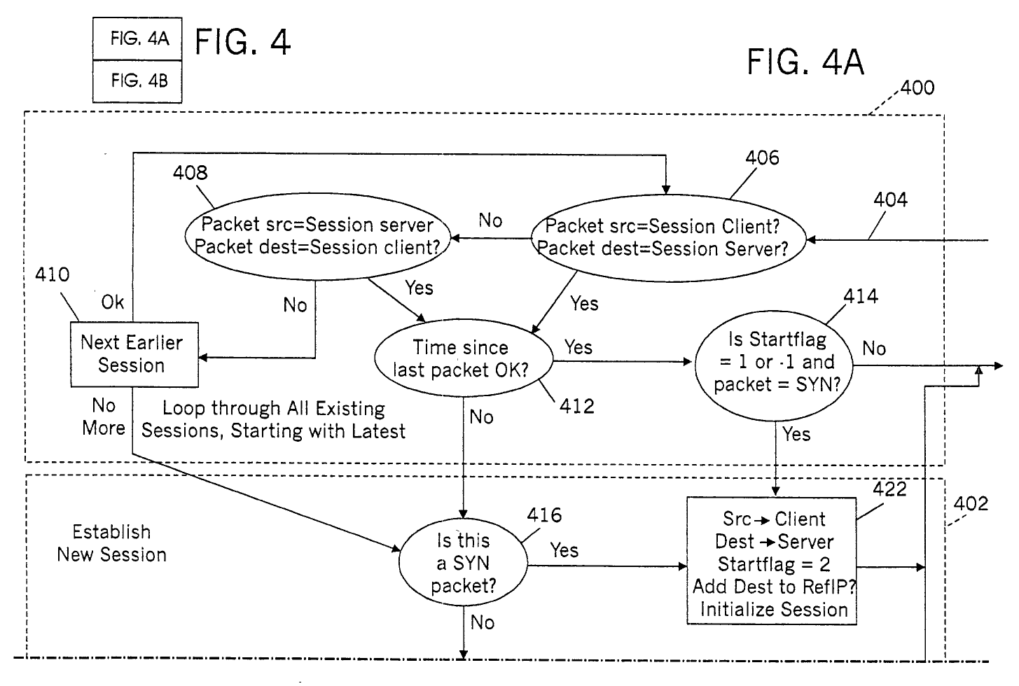

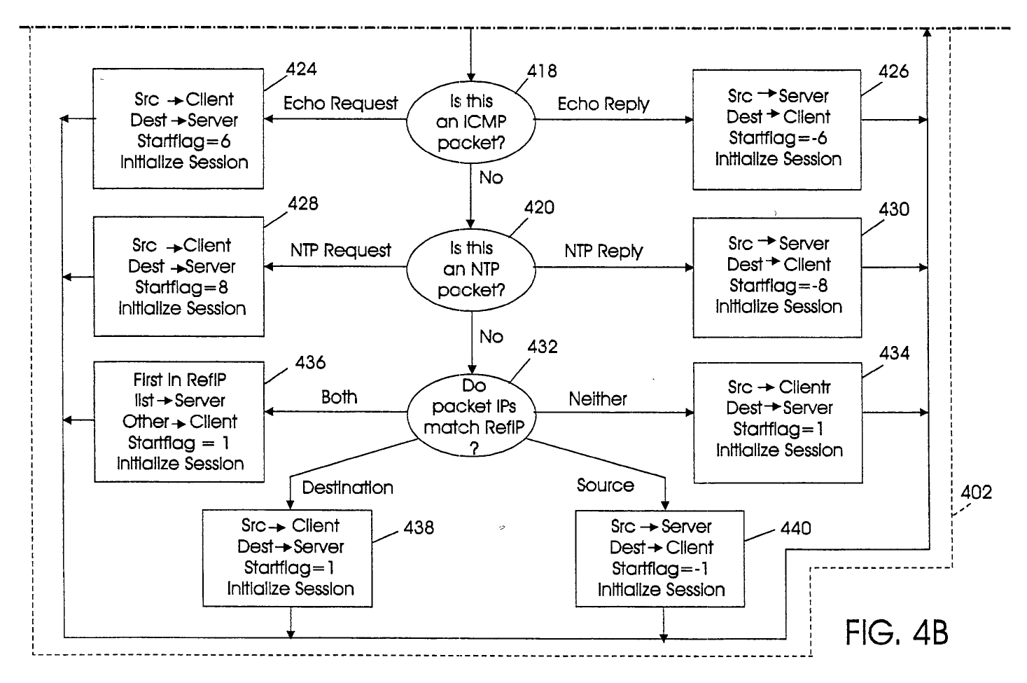

The next several flow diagrams illustrate how some of the specific processes referenced in FIG. 3 are carried out. FIG. 4 illustrates how a new packet is captured and associated with an existing session, or a new session if the packet is indicative of a new session being started. FIG. 4 is presented as FIGS. 4A and 4B for clarity. The steps illustrated in box 400 are related to looping through existing sessions to try to match the packet up, while the steps illustrated in box 402 are related to creating a new session. A packet is received from the TCP dump at 404. Steps 406 and 408 compare the packet source and destination IP addresses with those for existing sessions. The system starts with the most recent session and moves backwards at step 410 each time there is no match. Moving backwards is efficient because the packet is likely to be a continuation of an ongoing session and starting with the most recent sessions will often save searching time. Also, if a session is broken into segments because of a long gap in activity, it is desirable to have the new packet to be identified with the latest segment. If the packet source and destination IP addresses match some current session, time since the last packet in that session is checked at 412 against an operator-settable value to see whether the time gap is too great and a new session should be initiated.

If no matching session is found, if the time gap is too great, or if the Startflag for the matching session is +1 or −1 at step 414 (indicating a non-standard first packet for the session), a new session is established as indicated in the box. If the new packet is SYN at step 416, ICMP at step 418 or NTP at step 420, the relationship between packet source and destination can be used to unambiguously establish session client and server, as shown. In the case of a SYN packet, the Startflag is 2 at step 422. In the case of an ICMP packet, the Startflag is 6 for an echo request and −6 for an echo reply, as shown at steps 424 and 426, respectively. In the case of an NTP packet, the Startflag is 8 for a request at step 428, and −8 for a reply at 430. Otherwise an attempt to make an educated guess at the relationship using the RefIP value is made as described below. Note that the assignment of Startflag values is arbitrary, and simply represents a way to keep track of the logic that led to initiating a session.

Note that the destination address is also added to RefIP at step 422 of FIG. 4 if it was not previously included when a SYN packet for a new session is detected. RefIP contains a list of previously identified server addresses. This list is initialized to known system servers prior to program execution and servers are added as they are found during execution. Addresses occurring earlier in the list are more apt to be the “server” for some new session than those occurring later. If the new packet is a SYN for a session previously having a Startflag of +1 or −1, the session is re-initialized and earlier data are discarded. The educated guess is made by checking RefIP at step 432. If neither address in the packet matches anything in RefIP, a session is initialized at step 434. If both source and destination matches, the first occurrence in RefIP is taken as the destination at step 436. Otherwise, a single match results in the packet simply being associated with that address at step 438 for the destination address, and step 440 for the source address.

As previously mentioned, there is at least one class of network attacks that do not require accumulation of statistics and comparison with normal network behavior recognize the attack. This type of network attack is characterized by packet violations. Packet violations are of two general types: illegal packet header structures and content-oriented threats. The invention characterizes these attacks with the packet violation component metric, which, in the present example embodiment, is the only component that can alert the operator without normalization based on normal network behavior. In this case, the summary parameter and component metric are the same.

Some combinations of packet header information, such as packet source and destination indicating the same IP address, will not occur normally, so this is indicative of a particular network attack. Packets examined for these threats are outgoing packets (client-to-server) only. The following table shows the known threats that are detected in this way in the present embodiment of the invention, the condition that forms the basis for detection, and the metric ID values used as the component metric, which are then in turn used to identify the particular threat to an operator.

| Threat Type | Illegal Packet Structure | Metric ID |
|---|---|---|
| Ping-of- | Continuation packets form total packet | 3001 |
| Death | size greater than 64K | |
| Land | Source and destination show same IP | 3002 |
| | address | |
| Smurf | Client pings a broadcast address: | 3003 |
| | X.X.X.255 that is not part of an IP sweep | |
| | (e.g., previous ping is NOT X.X.X.254) | |
| Teardrop | Pathological offset of fragmented packet | 3004 |
| Bad offset | Inconsistency in offsets of fragmented | 3005 |
| | packets | |
| SynFin | SYN and FIN flags both set | 3006 |

In the present embodiment of the invention, some threats are detected by recognizing sub-strings in the summary field of the highest protocol level which are present in a particular threat but are very unlikely to occur in that field otherwise. Packets examined for these threats are outgoing packets (client-to-server) only. One occurrence suffices to identify the threat. The following table shows these threats as recognized in the present example embodiment with the metric ID's, which become the component metric value for the packet violation metric.

| Threat Type | Protocol | String | Metric ID |
|---|---|---|---|
| ps | Telnet | “get psexp.sh” | 3101 |
| back | HTTP | “//////” | 3102 |
| back | HTTP | “\\\\\\” | 3102 |
| secret | Telnet | “cd /home/secret” | 3103 |
| ftp-write | FTP/TCP | “RNTO .rhosts” | 3104 |
| eject | Telnet | “eject.c” | 3105 |
| crashiis | HTTP | “Get ../..” | 3106 |

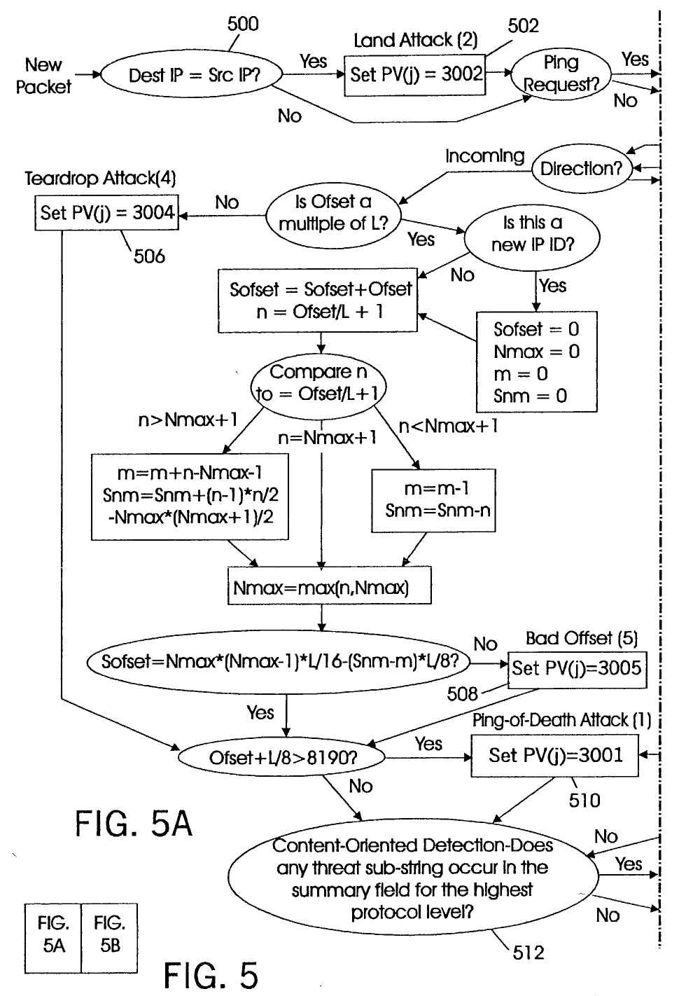

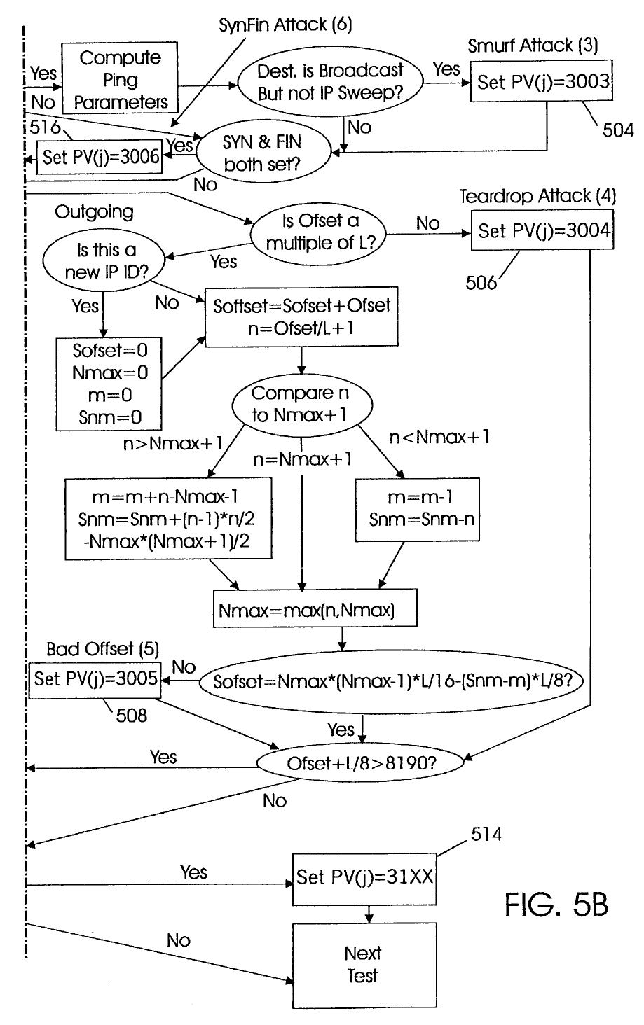

FIG. 5 is a flow diagram illustrating further detail on how the packet violation tests are performed. FIG. 5 is divided into FIGS. 5A and 5B for clarity of presentation. PV(j) denotes the packet violation metric value for session j. The metric is 3000 plus the number assigned to the attack. Each step in the flow diagram where a metric is assigned is labeled with this number in parenthesis. If destination and source IP addresses are identical at step 500, the packet is a Land attack, and PV(j) is set to 3002 immediately at step 502. Other assignments are made based on the flow diagram at steps 504, 516, 506, 508, and 510. For example, if the packet is a ping request, the destination is a broadcast address (X.X.X.255), and the previous ping request in that session was not X.X.X.254, indicating that the current packet is not part of an IP sweep, the attack is a Smurf attack and PV(j) is set to 3003 at 504. If both the SYN and FIN flags are set, the attack is a SynFin attack and PV(j) is set accordingly at 516.

The other test logic for packet header structure works with the offset value in the IP header, which is non-zero only if the packet is a continuation packet. The variables shown have the following values:

Ofset=offset in IP header

L=total length in IP header minus 20

IP ID=identification in IP header

Dest IP=destination in IP header

Src IP=source in IP header

Sofset=running sum of offset values

n=current packet fragment index

Nmax=highest packet fragment index received

m=number of late-arriving packet fragments still not received

Snm=contribution of offset value running sum corresponding to packets still not received.

Successive continuation packets should have offsets, which are successive multiples of the data portion of the IP packet, which is the total length of the IP packet minus the header size of 20. If an offset is not such a multiple, it is considered a pathological offset which is indicative of a Teardrop attack, and PV(j) is set to 3004. To see whether there is a bad offset value which is a proper multiple of the IP data size, a running sum is kept of the offset values (Sofset), which can be calculated from the number of continuation packets received. This logic allows for the fact that the continuation packets might arrive out of order. Note that the intermediate values (Sofset, Nmax, m and Snm) are accumulated separately for each session and each direction. The final continuation logic test examines the total (reconstructed) packet size, which is limited to 64K. If the size exceeds that value, it is presumed that we have a Ping-of-Death attack, and PV(j) is set to 3001.

The final test in FIG. 5 is performed at step 512. The test is for content-oriented threat detection, performed only on outgoing packets. If a sub-string in the summary field of the highest protocol level matches a threat type sub-string, PV(j) is set to the proper identifier indicative of that threat at step 514, as covered in the previous table. Since Telnet sends only a single character at a time, a string of 20 characters is kept for testing on each Telnet session. Each new Telnet character is appended on the right end of that string, and the left-most character is dropped.

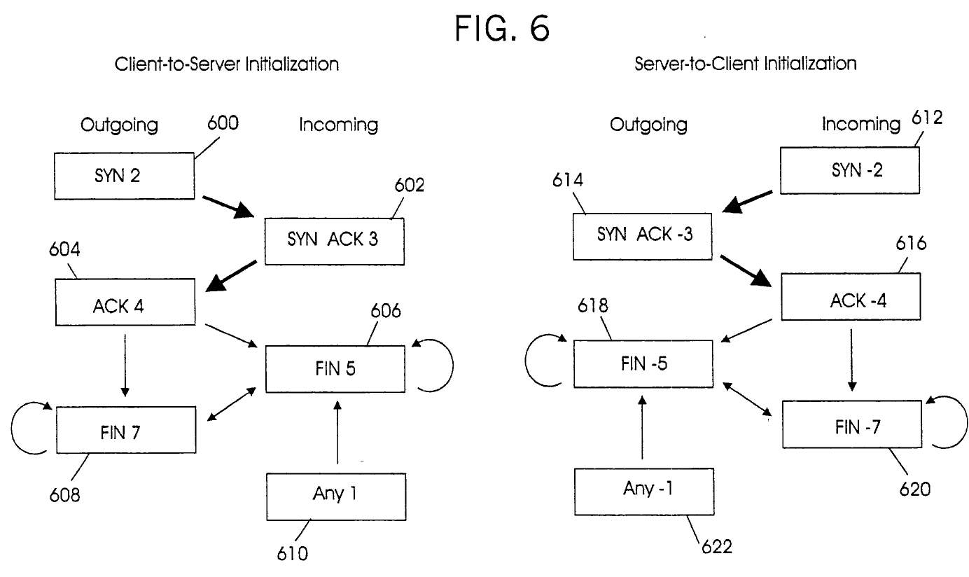

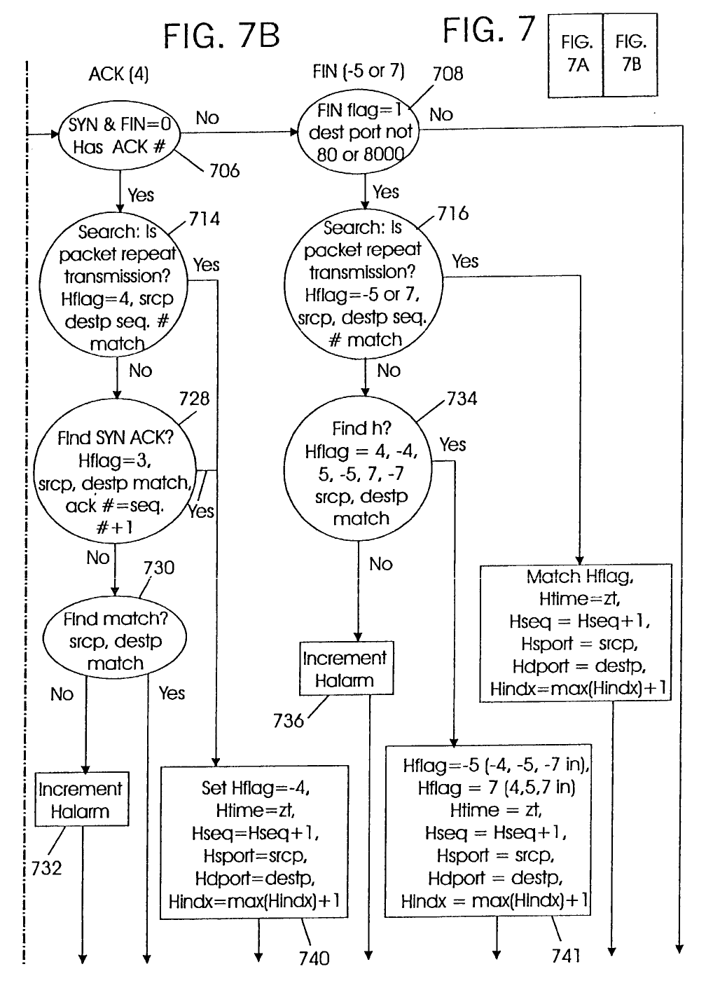

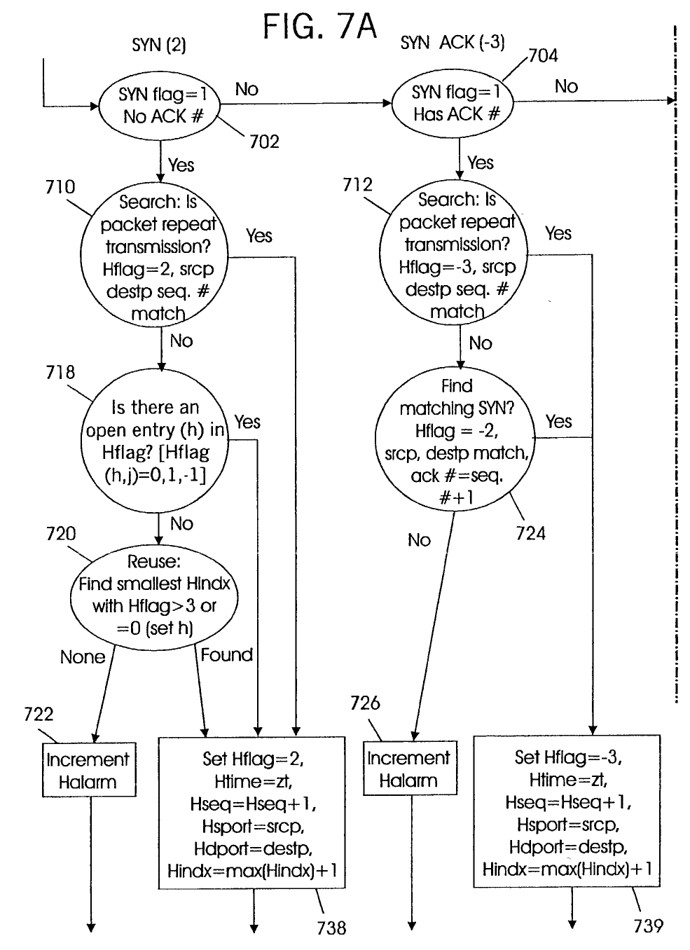

FIGS. 6 and 7 describe how handshake parameter violations are monitored and used to produce a summary parameter in accordance with some embodiments of the invention. FIG. 6 presents a high-level overview of how handshake violations are determined. Many denial-of-service attacks and network probes employ violation of the TCP handshake sequence. The invention implements a detailed analysis of that handshake sequence. FIG. 6 shows the transitions that are allowed. The usual handshake sequence is SYN, followed by SYN ACK, followed by ACK, and this is shown at 600, 602, and 604 for client to server initialization and at 612, 614, and 616 for server to client initialization, respectively. FIN packets are not usually considered part of the handshake sequence. However, since out-of-sequence FIN packets can also be used to mount an attack, the algorithm of this embodiment of the invention generalizes the handshake sequence to include FIN packets, as shown at 606 and 608 for client to server and 618, and 620 for server to client. Packets indicated at 610 and 622 can be any packet except SYN or SYN ACK. For transitions indicated in bolded arrows, destination and source ports, and acknowledgement number are verified. For transitions indicated in normal arrows, only destination and source ports are verified. Violation of the allowed sequence structure leads to an alarm condition. Note that the flag values in FIG. 6 represent the current state of the session within the handshake sequence, so that they are not “startflags” in the same sense as the flag values shown in FIG. 4.

As a new SYN, SYN ACK, ACK or FIN packet is received for a given session it is checked for consistency with previously received packets from the same session. All protocol transitions require consistency of source and destination port numbers for the new packet compared to the last packet received from the same sub-session. In addition, SYN to SYN ACK and SYN ACK to ACK transitions require consistency of the acknowledgement number with the most recently received packet in the sub-session.

Each session description can consist of several sub-sessions. Subsessions exist in this case because Internet usage often experiences the initiation of a new sub-session (SYN, SYN ACK, ACK) before an earlier subsession is closed out. Since several sub-sessions (often associated with Internet traffic) may be active within one session between two IP addresses, it is necessary to identify a packet with its appropriate subsession. Identification is achieved by verifying that the packet sequence is correct (e.g., ACK follows SYN ACK), that destination and source ports appropriately match those for the subsession, and that the new packet's acknowledgement number has the right relationship to the previous (subsession) packet's sequence number.

When FIN packets are checked, verification of acknowledgement number is dropped, since many other packets may intervene. Accurately following the sequence-acknowledgement number sequence would be expensive computationally. Allowance is made for re-transmission of packets due to non-reception of the original packet. It is an engineering design decision as to how many subsessions of this type to allow in a session. Ten subsessions per session has been found to suffice, but one of ordinary skill in the art can use any number needed. Although a significant number of sessions will exceed ten subsessions over time, by the time another sub-session is needed an earlier sub-session usually will have been closed out and re-use of sub-session designations is allowed. Once a sub-session reaches the ACK or FIN stage, it may be re-used. Criteria for re-use are that all ten sub-sessions have been occupied, and that the subsession in question is the oldest eligible subsession. Violations of the handshake sequence or overflow of the allowed subsessions due to none being available for re-use are tallied for each session, and serve to generate the handshake violation rate metric, facilitating the detection of other types of attacks besides SYN attacks. This handshake protocol violation rate also features the approach of using packet count instead of time as a rate reference to ensure sensitivity to stealthy low data rate probes as well as high data rate attacks.

FIG. 7 is a flow diagram that shows further detail of the process of creating a summary parameter based on handshake violation traffic parameters. FIG. 7 illustrates the process for outgoing packets. The process for incoming packets is almost identical and the differences between it and the process for outgoing packets are discussed below. The table below lists variable names associated with the session—subsession structure. Index h refers to subsession (in this embodiment, 1 to 10). Index j refers to session. Variable names beginning with “H” refer to descriptors associated with the session—subsession structure. Other variable names refer to corresponding quantities associated with the packet being processed.

| Variable | Function |
|---|---|
| srcp | Source port number |
| destp | Destination port number |
| seq # | Packet sequence number |
| ack # | Packet acknowledgement number |
| Hflag(h,j) | Handshake sequence flag |
| Hindx(h,j) | Index of sub-session creation order |
| Htime(h,j) | Time associated with latest packet |
| Hseq(h,j) | Packet sequence number |
| Hsport(h,j) | Source port number |
| Hdport(h,j) | Destination port number |
| Halarm(j) | Alarm indicator for session |

FIG. 7 shows the logic flow for the TCP handshake processing of an outgoing packet. FIG. 7 is presented as FIGS. 7A and 7B. The packet is first analyzed to see whether the packet is one of the elements of the handshake process, SYN at 702 (no ACK number), SYN ACK at 704, ACK at 706, or FIN at 708. If not, there is no further analysis required. Then a check is made to determine if the packet might be a re-transmission of an earlier handshake component at any of 710, 712, 714, 716 depending on the which element the packet represents (otherwise we might erroneously label it a violation of handshake protocol). If the packet is SYN, a determination is made at 718 and 720 as to whether a new sub-session can be opened; if not, there is an excess number of SYN initiations that were not completed, and Halarm is incremented at 722 since this is probably indicative of a SYN attack. If the packet is SYN ACK, a check is made at 724 to determine whether it is responding to an open SYN. If not, a SYN ACK attack or probe is indicated and Halarm is incremented at 726. Likewise, if the packet is ACK, a check is made to determine whether it is responding to an open SYN ACK at 728. If not, a check is made at 730 to determine whether its source and destination ports are consistent with an existing subsession, since ACK's are commonly used in normal session communication. If not, the ACK may be part of an ACK attack or probe so Halarm is incremented at 732. Once processing has passed beyond the initial SYN-SYN ACK-ACK sequence, acknowledgement and sequence numbers are not tracked, since that would require a lot of logic and processing. Finally, if the packet is FIN, a check is made to determine whether it represents a legal continuation of allowed packet transitions at 734. If the packet has not been preceded by a valid handshake opening sequence, it may be part of a FIN attack and Halarm is incremented at 736.

When processing is first begun, the system is likely to see a few apparent violations simply because we have missed earlier portions of a valid handshake sequence. Thus the component metric for handshake violation has a threshold greater than one to avoid false alarms. At 738, 739, 740, and 741, values used to keep track of the current handshake state details are updated. The meaning of the values indicated in at these steps in FIG. 7 are given in the table above.

The logic flow for processing an incoming packet is almost identical to that for an outgoing packet, with the obvious changes to reflect the different packet direction. The one significant difference is that subsessions initiated with 1 or −1 (primarily at startup, when earlier portions of a valid handshake sequence have been missed) are converted to valid handshake sequence logic by an incoming FIN packet. This transition is not enabled for an outgoing FIN packet because an attacker might generate FIN packets as part of the attack or probe.

Another component metric in the present embodiments of the invention is based on failed logins. To produce the summary parameter, the system looks for attempts to guess passwords by looking for failed login attempts. The system of the present example uses two primary methods to detect these failed login attempts: recognition of the return message from the server that the login ID/password combination was not acceptable; and recognition of a two-element sequence from the client that is characteristic of a login attempt. The fields available for scanning are the packet header and the summary field of the highest protocol level in the packet.

Recognition of the return message is used for Email (POP3) and Telnet. If an incorrect login ID/password combination is encountered by the mail server, it returns a packet whose summary field for the POP3 protocol level contains the sub-string “Authentication failure”. A Telnet login failure returns “login incorrect”. As these sub-strings would be extremely unlikely to be encountered in the summary field in normal traffic, they are taken to indicate a login failure.

Login to an internal address such as a document management system, or the World Wide Web presents a different problem, and therefore, detection in this case uses the two-element sequence. These login sequence packets contain appropriate sub-strings for identification, but in the text associated with the packet, not in the HTTP protocol summary field. The system does not open the search for a substring to the entire packet text because: (1) Processor time required to perform the search would increase significantly since the region to be searched is much larger on average; and (2) There would be more likelihood of finding the critical sub-string somewhere in the totality of a normal message rather than in just the summary field of the highest protocol level, therefore incorrectly concluding that a login failure has occurred.

As an example, the phrase “GET/livelinksupport/login.gif HTTP/1.0” occurs in the HTTP protocol summary field for one client-to-server packet that is part of the login sequence, and identifies initiation of Livelink login sequence. The phrase “GET/livelink/livelink?func=11&objtype=141&objaction=browse HTTP/1.0” occurs in the HTTP protocol summary field for one client-to-server packet that only appears after the server has determined that the login ID and password are acceptable. (One can pick an initial sub-string (“GET”) and a final sub-string (“login.gif HTTP/1.0” and “objaction=browse HTTP/1.0”) to avoid problems with site-specific directory structures.) Recognition of the first element triggers incrementing a login failure counter by 1. A sufficiently large value in that counter indicates a significant number of incomplete login attempts. Recognition of the second element means that the client has the correct User ID/password combination, at which point testing for that particular application is suspended. There are two reasons to suspend this password test once it is successfully passes. Firstly, the client knows the correct password, and will not continue guessing, so eliminating the test saves processing time; and secondly, the possibility that the first element will occur again later in the session for a different purpose than login and therefore be misinterpreted as a login is eliminated. The table below summarizes the text sub-strings used for recognizing password guessing in at least some embodiments. These strings may require tailoring for each installation site. Such tailoring is easily within the grasp of a network administrator of ordinary skill in the art.

| Application | Method | Protocol | String 1 | String 2 |
|---|---|---|---|---|
| POP3 | Return | POP3 | “Authentication | |
| | | | failure” | |
| Telnet | Return | Telnet | “login incorrect” | |
| Livelink | 2-Ele- | HTTP | “GET” | “objaction=browse |
| | ment | | “login.gif | HTTP/1.0” |
| | | | HTTP/1.0” | |
| WWW | 2-Ele- | HTTP | “GET http:www.” | “HTML Data” |
| | ment | | | |

Failed login attempts are to be expected in normal operation due to typing mistakes and incorrect recall of the password. Thus, in this example, an alarm is sounded only after the number of failed logins exceeds a small value, of order 4 (this limit can be site tailored).

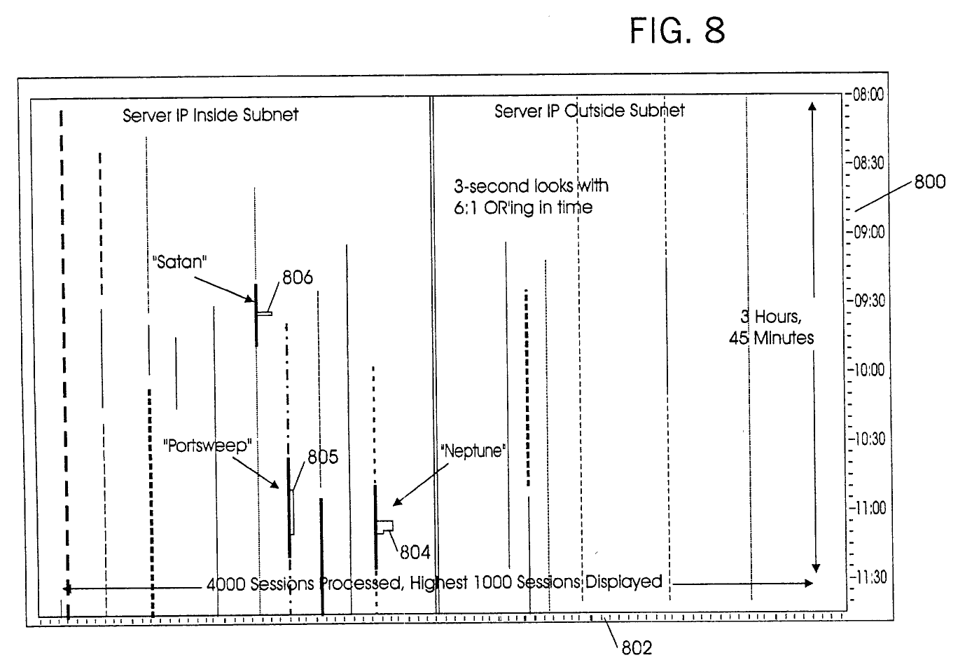

Reduction of the multi-dimensional metric space to a single distance parameter enables a comprehensive display, which is referred to herein as a “gram-metric” display, to alert an operator to all network events of significance over recent time. FIG. 8 portrays the video display format for the gram-metric display generated using the metric distance developed above. On this display time runs along the vertical (Y) axis 800, and sessions are presented along the horizontal (X) axis 802. The distance metric for each session at each look time is mapped into the sequence of integers available to describe gray levels, by first taking the logarithm of the metric level and then mapping that into the gray level range. The lowest value corresponds to black and the highest level corresponds to white for maximum visibility of the displayed structures. This results in pixels displayed on a black background. Note that FIG. 8 is black/white reversed for clarity of the printed image. The gray level for a particular session at a particular time is painted on the display at the coordinates corresponding to that session and that time. In addition, if the metric value is above some threshold, a colored “shadow” (for example, pink) is painted to the side of the pixel whose length is related to the amount that the metric value exceeds the threshold as shown at 804, 805, and 806. The legends, including those indicating specific types of attacks, “Satan”, “Neptune”, and “Portsweep”, are meant to clarify the illustrative example display in the drawing—such legends may or may not appear in an actual display. An implementation could easily be developed where more than one threshold is set, and the shadow is one color if the first threshold is exceeded, another color for the next threshold, etc. This serves to alert the operator to the most threatening developments. As new look data become available, they are painted in a horizontal line at the bottom of the display and the older data automatically scroll upward. That newest set of data paints several pixels at a time to enhance visibility of new threatening activity (earlier time looks paint only a single pixel).

In this particular display, a vertical line separates the display into two regions: sessions displayed to the left of the line have server IP's inside a defined collection of subnets; those to the right have server IP's outside those subnets. These subnet definitions are site specific and therefore site tailorable. Such a delineation can be used to highlight sessions originating inside vs. outside a firewall. The legends in the figure are descriptive of the range of values displayed and the types of threat sessions visible in this segment of data and are not ordinarily displayed. Since the display surface is limited in number of pixels that can be displayed, means are provided to handle a larger range of values. In this example embodiment, when more than 1000 sessions are current, the operator has a choice of displaying the 1000 sessions showing the highest metric values, or displaying all sessions and scrolling the display in the horizontal direction to view them. Similarly, the operator has the option of OR'ing in time to increase the time range visible in the display, or viewing all time pixels by scrolling vertically.

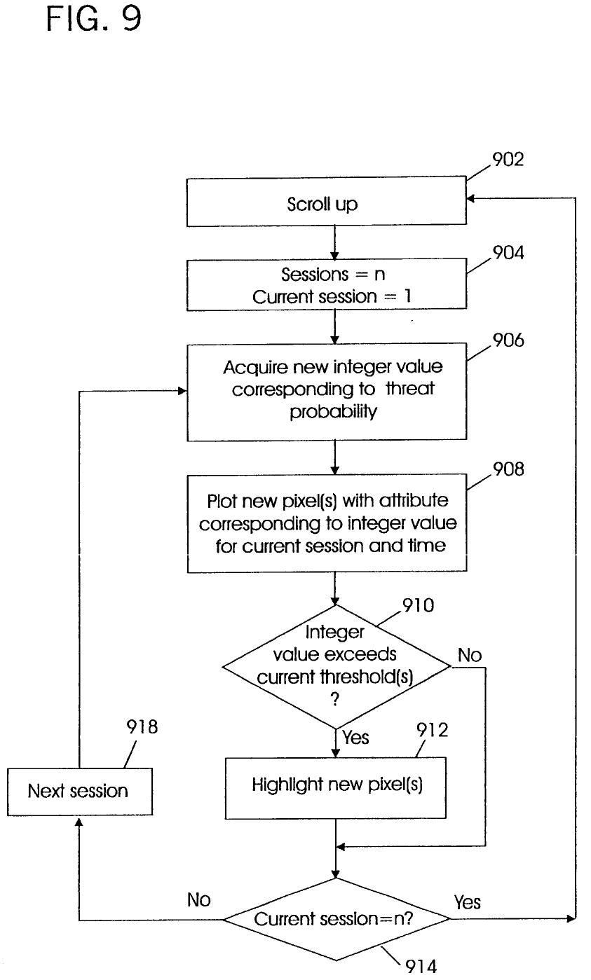

It is important to recognize that the gram-metric display described above can be created and updated based on any threat metric that constitutes a single numerical value that characterizes the threat to a network of a particular session at a particular time. This numerical value need not have been generated by the multi-dimensional plotting and distance algorithm that has been discussed thus far. It can be generated by any algorithm, or even wholly or partly by manual means. All that is required to create the gram-metric display according to this embodiment of the invention is a single value characteristic of the threat, that can then be mapped into an integer scale useful in setting gray level or any other display pixel attribute. FIG. 9 illustrates the process for creating and updating the display in flowchart form. It is assumed an integer value is provided that corresponds to the described display attribute, in the case of gray levels, a single value on a scale of 256.

The display is created with sessions along the X axis, time along the Y axis, and a local pixel attribute representing an integer value of threat probability. Each time step 902 is reached, the display scrolls upwards. At step 904, the current number of sessions is set, and processing is set to the first of these. At step 906, a new integer value is obtained and plotted for the current session and time. At 910, a check is made to determine if that value exceeds a set threshold. It is assumed for purposes of FIG. 9 that the embodiment described operates with only one threshold. If the threshold is exceeded, the new pixel or pixels are highlighted at step 912, as with the color shadow previously described. If the threshold is not exceeded, processing continues to step 914, where a determination is made as to whether all sessions have been plotted for the current time. If not, plotting of the next session begins at 918. If so, plotting for the next time begins as the display scrolls upwards at step 902. (It could also be implemented to scroll downwards.) At this point, the number of sessions is updated if necessary, as it may have changed and the current session is again set to the first one. The updating of the number of sessions may require re-drawing on the screen since the X axis scale may need to be changed. In any case, data for past times is simply re-displayed from memory when the display is updated. The process of doing calculations and determining at what intensity to display the data is only carried out for the most recent time.

The display system of the present invention employs a capability to dynamically adjust the effective detection threshold and the display contrast in the region of that threshold to aid the operator in evaluating ambiguous events. FIG. 10 illustrates a graphic that might be displayed and controlled with a mouse to accomplish this, and therefore lends to an understanding of how this works. The three curves represent three one-to-one mappings of distance metric value into display gray level. The X position of the control point sets the detection threshold (the place where the mapping curve crosses the output level 0.5, shown by the dotted horizontal line) and its Y position sets the contrast (slope where the mapping curve crosses the output level 0.5). As the operator moves the control point the mapping is continually recomputed and the change in the display is immediately visible. Three possible positions for the control point and mappings for those three positions are shown in FIG. 10. Control point 1002 corresponds to mapping line 1012, control point 1003 corresponds to mapping line 1013, and control point 1004 corresponds to mapping line 1014. This kind of dynamic change can make the operator aware of subtle features that are not obvious in a static display.

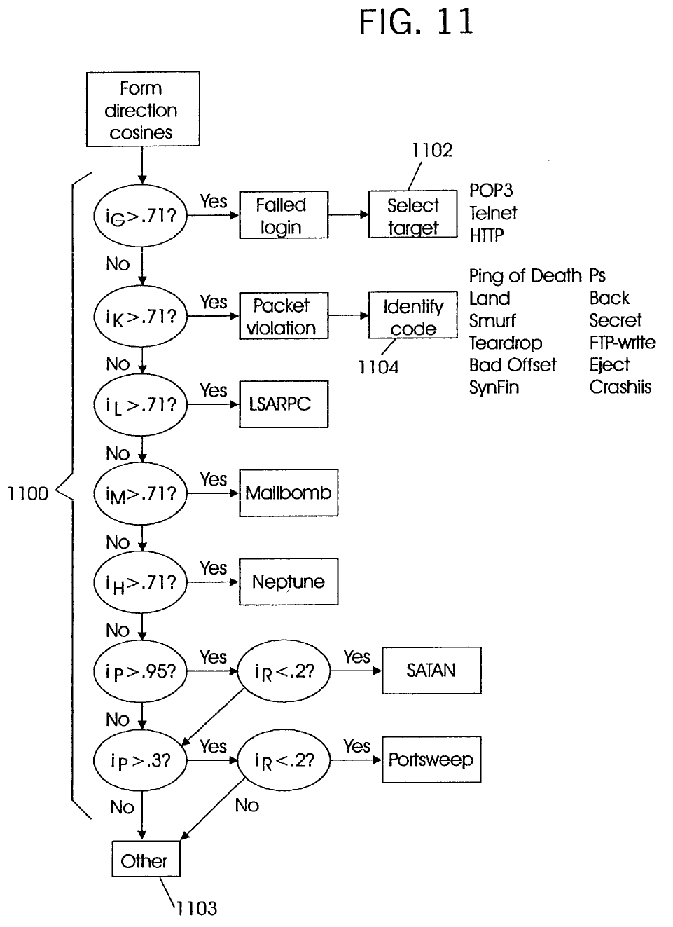

FIG. 11 illustrates a logic flow behind another display feature. When a potential attack has been identified on the display it is highly advisable to identify the probable nature of the attack. The operator can click or double-click (depending on implementation) on the attack trace on the display, and a window will pop up giving identifying characteristics such as source IP address, destination IP address and an estimate of probable attack type.

FIG. 11 shows a schematic representation of the vector analysis by which attack type is diagnosed from individual component metrics associated with the attack session. Values of the following seven metric components are squared, added and the square root is taken.

i_{G}=login failures

i_{K}=packet violation

i_{L}=LSARPC rate

i_{M}=mail SYN rate

i_{H}=handshake violation

i_{P}=port change

i_{R}=RST rate

Then each component is divided by that square root to form the set of direction cosines in a 7-dimensional space. The cosines are tested for values as indicated at 1100 in FIG. 11. Discrimination test values were based on observed metric values obtained. The values can be modified if necessary, and other threats can be added based on observed values for a particular network installation. Note that for failed login the server can be displayed. Also, codes for packet violations can be given at 1104 when a packet violation is identified. The codes from FIG. 5 are used. Alternatively, the system can be designed to translate these into text, as shown in FIG. 11. While it is certainly possible to implement all the functions of the invention on a standalone personal computer or workstation, for most networks, it may be desirable to split the data capture/parameter measuring functions with the analysis/display functions onto two types of workstations. The former is referred to herein as a monitoring agent or data capture station, and the latter is referred to herein as an analysis station. Either type of station can be implemented on a general purpose, instruction execution system such as a personal computer or workstation. In the example embodiments discussed herein, the analysis station also maintains the historical data. This split of function does mean that some network traffic is devoted to exchanging data between the workstations involved in implementing the invention. However, the amount is small thanks to the fact that only metrics which consist largely of moments or other summary values for the network traffic parameters are sent from the monitoring agents to the analysis station. That communication can occur either on the network being monitored, or, for higher security, on a separate, parallel network.

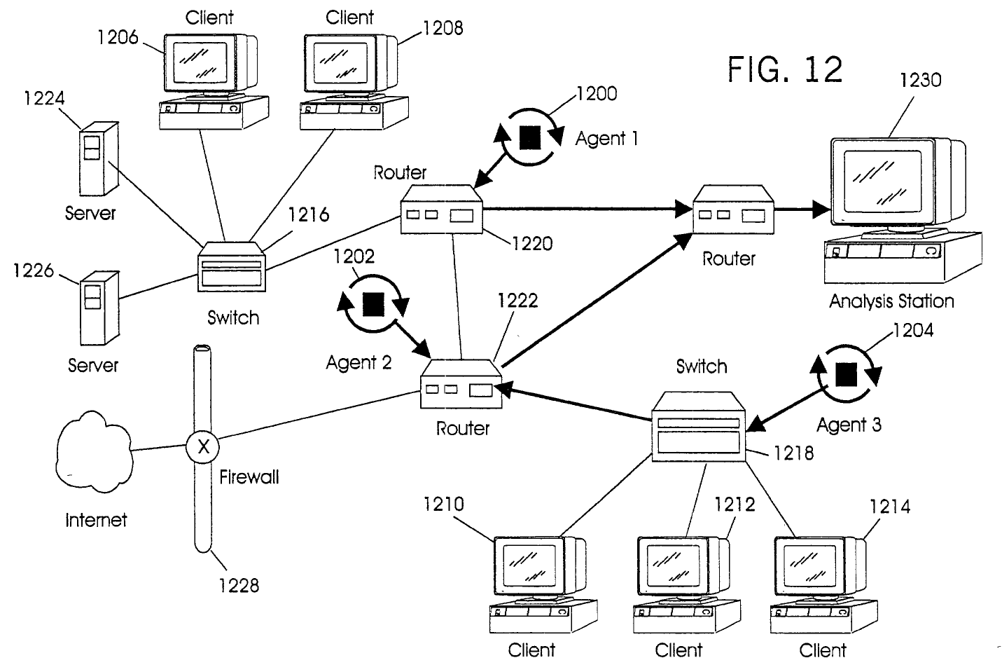

The system consists of an unspecified number of data capture stations and one (or more) analysis stations. FIG. 12 is a representative network block diagram, where three data capture stations serving as monitoring agents, 1200, 1202, and 1204 (also labeled Agent 1, Agent 2 and Agent 3) are each capturing all the data they are capable of seeing. They digest the data from all packets, sorting it according to session (which is a unique combination of IP addresses), and obtaining network parameters from which summary parameters (some of which may be the component metrics themselves) are created (moments and related descriptors). These summary parameters for each session are sent back over the network periodically (perhaps every three or four seconds, which is called herein, the look interval) to the analysis station, as indicated by the arrows.

The network of FIG. 12 is typical, but there are infinite network configurations in which the invention will work equally well. The network of FIG. 12 also includes clients 1206, 1208, 1210, 1212, and 1214. Two switches are present, 1216 and 1218, as well as routers 1220 and 1222. Servers 1224 and 1226 are connected to switch 1216. Note that Internet connectivity is provided through firewall 1228. An analysis station could be placed outside the firewall, and firewall 1228 would then be provisioned to allow appropriate network traffic between outside monitoring again, and the analysis stations, 1230. The example of FIG. 12 shows only one analysis station. It would be a simple matter to include others.

Each data capture station is capable of being controlled (data capture started, stopped, etc.) by messages sent over the network or the parallel network, if so implemented, from the analysis station. Each data capture station has two network interface cards (NIC): one operates in promiscuous mode to capture all data flowing on the network segment it connects to, and the other serves to transmit messages to the analysis station and receive messages from the analysis station, 1230. Captured data on a common Ethernet network consists of all messages flowing in the collision domain of which the monitoring again is a part. In future networks which have evolved to switched networks, which have less extensive collision domains, data capture can be effected by mirroring all ports of interest on a switch onto a mirror port on the switch, which is then connected to the data capture station. Monitoring agents are installed only on those network segments where monitoring is required.

An analysis station consists of analysis software installed on an instruction execution system, which could be a personal computer or workstation. The analysis station needs to have some kind of video display capability in order to implement the gram-metric display. The analysis station combines the newly received data from the several data capture stations with previous data from each session. It associates with each session a distance in an N-dimensional space as previously discussed, indicating how far the session departs from “normal” sessions, and uses that distance to develop the threat metric. If more than one analysis station is used, the data capture stations are programmed to send each set of summary data to each analysis station.

Identification of which IP address characterizes the client (the other IP address of the session pair characterizes the server) is deduced from the sequence of packets observed. This process is not unambiguous: sessions may be initiated in a number of ways, and data capture may commence with a session that started earlier (so that the usual clues of initiation are not seen). One helpful clue is whether an address corresponds to a known server (E-mail, Internet, print server, etc.). Software implementing the invention may be initialized with such a list of known IP addresses of servers, although this is not required. The software can also be designed to have the capability to add to this list as packet processing proceeds. That list will become the RefIP list previously discussed.

Since only summary parameters are sent over the network, any need for a separate communications network for data transmission and command and control of the intrusion monitoring system is eliminated. In the course of a day a typical enterprise network may have seen several thousand client-server sessions. By transmitting only the parameter updates needed for only those sessions that were active during one look (a time period for network analysis, of order a few seconds), network loading due to this transmission process is reduced. In this example embodiment, for each active session, in addition to two identifiers for each session (client and server IP address), 23 summary parameter quantities are accumulated to eventually produce 17 component metrics:

Sums of powers 1 through 4 of the time difference between successive outgoing packet captures in a session;

Sums of powers 1 through 4 of the inverse of time difference between successive outgoing packet captures in a session;

Sums of powers 1 and 2 of time difference between successive outgoing SYN packets in a session;

Change in session time (is usually the duration of a look);

Sum of sizes of packets in a session;

Number of client-to-server packets;

Number of SYN, FIN, RST, LSAR and ICMP ping packets;

Number of SYN packets directed to a mail destination port;

Number of packets where destination port did not change;

Number of handshake violations;

Number of failed log-ins;

Code for any observed packet violation; zero otherwise.

Bytes allocated for transmission across the network to the analysis station are IP addresses (4 each), packet size (3), time and moments (5 each), counts (3, 2 or 1 each). The majority of the time, the data transmitted once per look for each session active during the current look consists of only 94 Bytes. Even if 500 sessions were active during one look, the bandwidth required is only about 0.099 Mbit/sec., less than one percent of regular Ethernet bandwidth. The system described is essentially implemented as a programmable filter architecture, with intelligent monitoring sensors present at every monitored node. In effect, an analyst or system administrator can communicate with these sensors to define the filters, and to control the examination of data streams that make up the bulk of the functionality.

Multiple analysis stations may be useful so that network performance in one corporate location can be monitored by an operator local to that site, while overall corporate network performance for several sites could be monitored at a central site. Multiple analysis stations are easily handled: one copy of the summary data at each look interval is sent to each analysis station.

In the case of multiple monitoring agents, data from separate collision domains must be combined into a characterization of a larger network. This is particularly important in the case of switched networks, where multiple workstations connected to a single switch are combined by mirroring the switch ports into a single mirrored port. Then outputs of multiple switches are collected by use of one agent monitoring each switch. It is also possible to instead use another switch to combine the mirrored output from several switches, then mirror those inputs into a “super-mirror” port, each output of those “super-mirror” ports then feeding a detection station. The primary concern in aggregating multiple ports into a mirror port is that the total traffic not approach the bandwidth capability of the mirror port.

A complication in handling multiple detection stations (or even the output from one mirror port) is that the same packet may be seen at multiple locations, giving rise to unwanted multiple copies of the same packet occurring in the summary parameters. Thus it is necessary to recognize and delete the extra copies of the same packet. One of the data capture stations is designated as the reference agent; packets from other collection stations that do not match some packet at the reference agent sequence are added into the reference agent sequence. Thus the reference agent sequence becomes a union of the traffic seen on the various parts of the network. This merging of the data streams is performed in the analysis station. Copies of the same packet on the reference agent station occurring on other monitoring agents also contribute to time synchronization of the PC's serving as the data capture stations, as discussed below.

What constitutes the same packet at two different network locations depends on the transport level protocol for the packet. To be the same packet, source and destination IP addresses, IP level, ID number and packet size must agree. If the transport level protocol is TCP or UDP, source and destination port numbers must agree. If the transport level protocol is TCP, sequence and acknowledgement numbers must agree. Finally, packet capture times must agree within a specified tolerance (this limits the number of packets in the reference stream that must be searched for comparison).

First consider the case of a session on a switched network where source and destination machines are attached to the same switch, which means that we expect two copies of the same packet on the mirror port. Only the reference agent station data is searched here, and no time synchronization data are collected. This search is not necessary if the reference agent data are not coming from a mirror port.

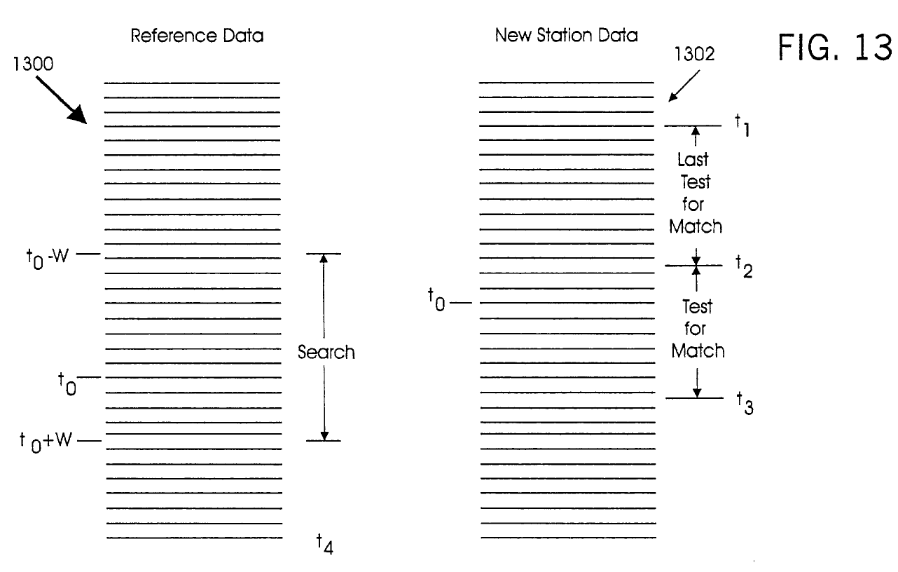

Next the additional data capture stations are compared one by one with the reference agent data (possibly already augmented by packets from other monitoring agent). The most recent packet in the current reference data look (the look interval is the interval between successive transmissions from a given data capture station) has time stamp t₄, as shown in FIG. 13. FIG. 13 shows a reference data time scale, 1300, along with a new station data time scale, 1302. Each packet from the new station data will be compared to packets in the reference data having time stamps within time w of the new station data packet time stamp. Thus the latest time stamp that can be considered for comparison testing is t₃=t₄−w. (New station data with time stamps later than t₃ will be compared with reference data after the next look is received.) The latest time considered for match from the previous look was t₂. Assume a packet index Nᵢ corresponds to a time tᵢ. The packet index N₂ corresponding to t₂ was saved during processing for the previous look. Thus all new station packets from N₂+1 to N₃ (the packet index for the last packet whose time stamp is less than t₃) will be compared against the reference data. FIG. 13 shows this comparison for one of those packets whose time stamp is to. That packet will be compared against all reference data packets with time stamps lying within time w of t₀. If a match is found, t₀ and the time corresponding to the matching reference data packet will be furnished to computation of time offset between the reference station and the new station. If no match is found, the packet corresponding to time t₀ in the new station data is added to the reference data. Normally, data collection for a given look begins with the arrival of a message from the reference station; earlier arrivals from other stations are ignored. It ends when exactly one message has been received from each data capture station. Once the comparison process is complete for all stations, computation of metric components may be performed.

One or more data capture stations may be off line; messages from those stations will not be received. In this case, data collection ends when a second message is received from some station. Generally this message will be from the reference station if it is healthy, since the messages are sent at regular (look) intervals and the process began with the reference station. Comparison is performed for the data capture stations reporting in; the fact that some stations are not active is reported to the analysis station operator, but otherwise does not affect system operation. If the reference data capture station fails to report, another active data capture station is selected automatically as the new reference data capture station. Comparison and computation of component metrics proceeds as with normal initiation of processing, except that the display continues with previous history rather than re-initializing. When the original reference data monitoring agent again reports in, it is reinstated as the reference data station agent, following the same procedure as the switch to a secondary reference data capture station.

The computer systems serving as the monitoring agents must be time synchronized. This should NOT to be done using NTP or SNTP, except perhaps once a day (in the middle of the night, when traffic is minimal) so the absolute times reported by each machine don't drift too far apart. The reason is that PC clock resets generated by NTP or SNTP would cause the time difference between two PC clocks to be a sequence of slightly sloping step functions, where the magnitude of the step discontinuities is of order a few milliseconds. These discontinuities could cause occasional confusion in the timing of the same packet as seen on two separate detection stations. Instead, consider the physics of how time is determined on most small computer systems, including PC's. Each PC contains an oscillator; counting the “ticks” of that oscillator establishes the passage of time for that PC. If all PC oscillators ran at exactly the same frequency, they would remain synchronized. However, the frequencies are slightly different for each oscillator due to crystal differences, manufacturing differences, temperature difference between the PC's, etc. Thus times on two PCs drift apart by an amount which is linear in time to a very good approximation, and is of order 1 to 10 seconds per day. If the linear relationship of this time drift are determined, a correction can be applied to time observed on the second PC that will result in synchronization of the two PC times to a few microseconds. Such synchronization accuracy constitutes two to three orders of magnitude more accuracy than would be obtained from NTP or SNTP.

This estimate of the linear drift can be made by identifying occurrences of the same packet at the two PC's (described above). Once the appearance of a given packet at both PC's is verified, the time difference between the time stamps at the two PC's provides a measure of the time difference between the PC's at that time. (This ignores transit time differences between the PCs due to intervening switches or routers, which is of the order of microseconds). Feeding these measurements into a least squares linear filter, with the addition of a fading memory filter with a time constant of a few hours, will yield a formula for the PC time difference at any time. If one is concerned about the delay due to the intervening switches and routers, the time difference can be estimated separately for each propagation direction and averaged.

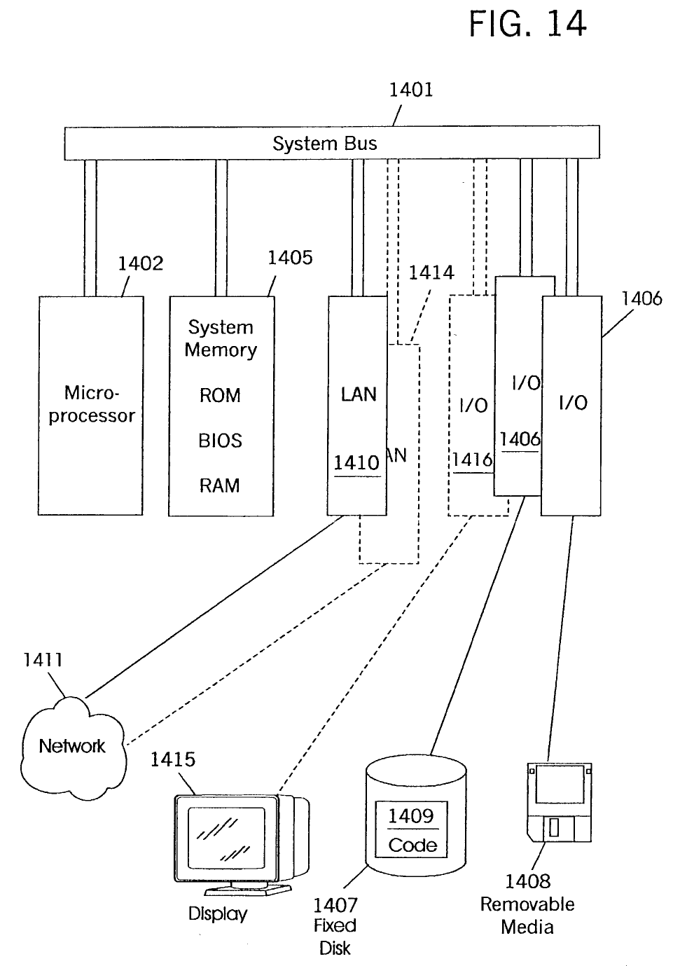

FIG. 14 illustrates an instruction execution system that can serve as either an analysis station or a data capture station in some embodiments of the invention. It should also be noted that one workstation could perform both functions, perhaps quite adequately in some networks. FIG. 14 illustrates the detail of the computer system that is programmed with application software to implement the functions. System bus 1401 interconnects the major components. The system is controlled by microprocessor 1402, which serves as the central processing unit (CPU) for the system. System memory 1405 is typically divided into multiple types of memory or memory areas such as read-only memory (ROM), and random access memory (RAM). A plurality of standard input/output (I/O) adapters or devices, 1406, is present. A typical system can have any number of such devices; only two are shown for clarity. These connect to various devices including a fixed disk drive, 1407, and a removable media drive, 1408. Computer program code instructions for implementing the appropriate functions, 1409, are stored on the fixed disc, 1407. When the system is operating, the instructions are partially loaded into memory, 1405, and executed by microprocessor 1402. The computer program could implement substantially all of the invention, but it would more likely be a monitoring agent program if the workstation were a data capture station, or an analysis station program if the workstation were an analysis station.

Additional I/O devices have specific functions in terms of the invention. Any workstation implementing all or a portion of the invention will contain an I/O device in the form of a network or local area network (LAN) adapter, 1410, to connect to the network, 1411. If the system in question is a data capture station being operated as a monitoring agent only, it contains an additional network adapter, 1414, operating in promiscuous mode. An analysis station, or a single workstation performing all the functions of the invention will also be connected to display, 1415, via a display adapter, 1416. The display will be used to display threat metrics and may produce a gram-metric display as described. Of course data capture stations can also have displays for set-up, troubleshooting, etc. Also, any of these adapters should be thought of as functional elements more so than discrete pieces of hardware. A workstation or personal computer could have all or some of the adapter entities implemented on one circuit board. It should be noted that the system of FIG. 14 is meant as an illustrative example only. Numerous types of general purpose computer systems and workstations are available and can be used. Available systems include those that run operating systems such as Windows™ by Microsoft, various versions of UNIX™, various versions of LINUX™, and various versions of Apple's Mac™ OS.

Computer program elements of the invention may be embodied in hardware and/or in software (including firmware, resident software, micro-code, etc.). As shown above, the invention may take the form of a computer program product, which can be embodied by a computer-usable or computer-readable storage medium having computer-usable or computer-readable program instructions or “code” embodied in the medium for use by or in connection with the instruction execution system. Such mediums are pictured in FIG. 14 to represent the removable drive, and the hard disk. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and the hardware described in FIG. 14 form the various means for carrying out the functions of the invention in the example embodiments.

The intrusion detection system discussed thus far involve sessions that are one-to-one: the session contains one client and one server. However, there are two types of attacks or probes that involve one client but multiple servers, or multiple clients but one server. Either of these is referred to herein as a “one-to-many” session or a “supersession” and their component sessions may be referred to herein as subsessions. An example of the first type is an IP Scan, where a single IP client “surveys” multiple IP addresses on the network to determine which IP addresses are active. An example of the second type is a distributed attack or scan, where an attack or scan that could have been mounted by one client is instead mounted (or made to appear as mounted, through spoofing of client IP addresses) from several clients. Analysis of these types of attacks in a system is performed in the analysis station portion of the invention using data from the component client-server subsessions, with the benefit that no extra network communication is required.

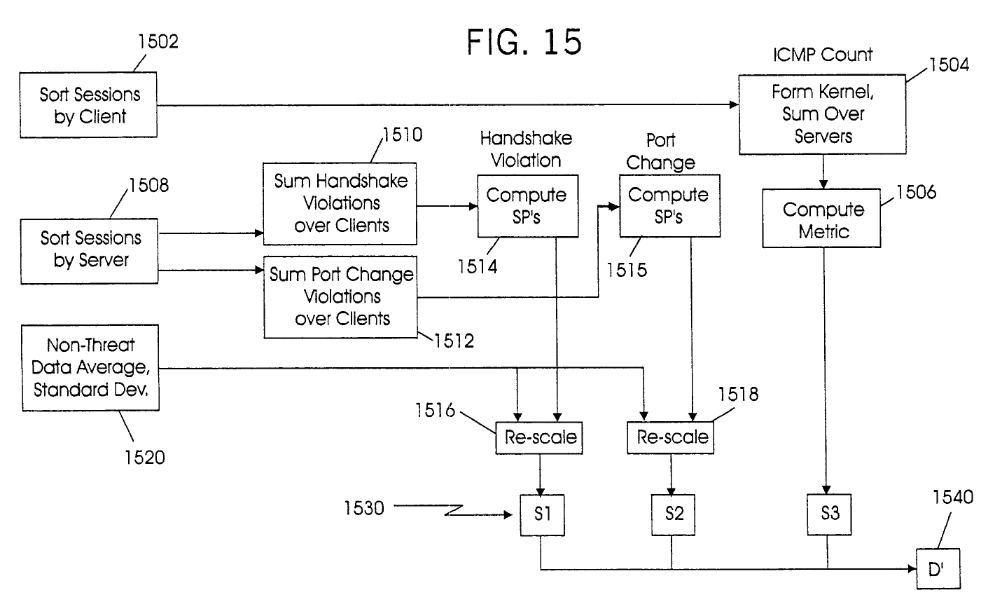

FIG. 15 extends the flow diagram of FIG. 1 to include these one-to-many sessions. The treatment is consistent with the 17 component treatment described above; the output can portrayed separately on the gram-metric display. An IP scan interrogates multiple IP addresses by addressing ICMP echo requests to them. If an ICMP echo reply is received, the IP address interrogated is active. Analysis begins by sorting the session data by client IP address at 1502. All servers accessed by a given client will be analyzed, looking for ICMP echo requests. A kernel which is a function of the number of ICMP echo requests and total number of packets in each session is computed at 1504, then summed over all sessions associated with that client. Thus this sum reflects the number of echo requests per session as well as the number of sessions containing echo requests (if there are no echo requests, the sum will be zero). To form the equivalent of a summary parameter at 1506, which in this case is the component metric, that sum is raised to a power, then limited not to exceed 100000 to avoid generating extremely large values in some cases. These one-to-many super-sessions (one for each client) can be displayed along with the one-to-one sessions, with the same detection characteristics applied.

Distributed scenarios can be used for attacks or scans. The system looks for handshake violations or destination port changes from multiple clients associated with a given server. Handshake and port change analysis is performed in parallel, with component metric value obtained for each component for each server. Analysis begins by sorting the session data by server IP address at 1508. As in IP scan detection, a kernel which is a function of the total number of packets and either the number of handshake violations or the number of port changes is computed, then summed over all subsessions associated with that client at 1510 and 1512. This kernel represents an event rate summary parameter at 1514 and 1515. To form the metric distance, that event rate sum is scaled at 1516 and 1518 by the equivalent quantity for normal background data, 1520, as was done for the metric components in one-to-one sessions to obtain a spherical distribution. Values obtained are directly commensurate with component metrics obtained for one-to-one sessions. These one-to-many supersessions (in this case, one for each server) can be displayed along with the one-to-one sessions, with the same detection characteristics applied. Component metrics in this case are designated S1, S2, and S3, and are shown at 1520. The threat metric is the distance of the point from the centroid for this super-session, just as before, and is designated D′ as shown at 1520. Detailed equations are included in the list at the end of the specification.

Specific embodiments of an invention are described herein. One of ordinary skill in the computing and networking arts will quickly recognize that the invention has other applications in other environments. In fact, many embodiments and implementations are possible. The following claims are in no way intended to limit the scope of the invention to the specific embodiments described above.

Listing of Input Data and Equations with Comments

Data required for each session (relevant data are mostly client-to-server):

First four moments of time between packets: Tn, where n is moment order.

First four moments of inverse of time between packets: Vn, where n is moment order.

First two moments of time between SYN packets: Rn, where n is moment order.

Session duration (seconds): D.

Average packet size: K.

Total number of client-to-server packets in session: P.

Total number of SYN packets in session: Y.

Total number of FIN packets in session: F.

Total number of RST incoming packets in session: R

Total number of LSARPC packets in session: L

Total number of ICMP (ping) packets in session: I

Total number of SYN packets in session where destination port indicates mail (24, 25, 109, 110, 113, 143, 158 or 220): M.

Total number of packets where destination port did not change: DP

Total number of handshake violations: NH

Total number of failed logins: FL

Code for most recent observed packet violation; zero if none: PV

Ignore all packets with TCP flag=10, 11, 12 or 18 and IP length=40, 41, 42, 43 or 44.

Form central moments (Sn, Un) from non-central moments:

S₁=T₁

S₂ =Max(T₂−T₁², 0)

S₃=T₃−3*T₂*T₁+2*T₁³

S₄=T₄−4*T₃*T₁+6*T₂*T₁²−3*T₁⁴

U₁=V₁

U₂=Max(V₂−V₁², 0)

U₃=V₃−3*V₂*V₁+2*V₁³

U₄=V₄−4*V₃*V₁+6*V₂*V₁²−3*V₁⁴

Q₁=R₁

Q₂=Max(R₂−R₁²,0)

Form standard deviations:

s=\sqrt{S₂}

u=\sqrt{U₂}

q=\sqrt{Q₂}

Normalize moments:

$$\begin{matrix}\begin{matrix}\begin{matrix}\begin{matrix}\begin{matrix}{A}_{1} = \frac{{S}_{1}}{Max ( s , 0.5 * {S}_{1} * ( s < 0.01 * {S}_{1} ) )} \\ {A}_{3} = \frac{{S}_{3}}{{( Max ( s , 0.5 * {S}_{1} * ( s < 0.01 * {S}_{1} ) ) )}^{3}}\end{matrix} \\ {A}_{4} = \frac{{S}_{4}}{{( Max ( s , 0.5 * {S}_{1} * ( s < 0.01 * {S}_{1} ) ) )}^{4}}\end{matrix} \\ {B}_{1} = \frac{{U}_{1}}{Max ( u , 0.5 * {U}_{1} )}\end{matrix} \\ {B}_{3} = \frac{{U}_{3}}{( {Max ( u , 0.5 * {U}_{1} )}^{3}}\end{matrix} \\ {B}_{4} = \frac{{U}_{4}}{( {Max ( u , 0.5 * {U}_{1} )}^{4}}\end{matrix}$$

Form averages, standard dev. of normalized moments over all sessions with non-threat data:

\overline{A₁}=Avg(A₁ᵢ)

\overline{A₃}=Avg(A₃ᵢ)

\overline{A₄}=Avg(A₄ᵢ)

\overline{B₁}=Avg(B₁ᵢ)

\overline{B₃}=Avg(B₃ᵢ)

\overline{B₄}=Avg(B₄ᵢ)

{double overscore (A₁)}=St.Dev.(A₁ᵢ)

{double overscore (A₃)}=St.Dev.(A₃ᵢ)

{double overscore (A₄)}=St.Dev.(A₄ᵢ)

{double overscore (B₁)}=St.Dev.(B₁ᵢ)

{double overscore (B₃)}=St.Dev.(B₃ᵢ)

{double overscore (B₄)}=St.Dev.(B₄ᵢ)

Form first 6 metrics from re-scaled values of normalized moments:

C₁=(A₁−\overline{A₁})/{double overscore (A₁)}

C₂=(A₃−\overline{A₃})/{double overscore (A₃)}

C₃=(A₄−\overline{A₄})/{double overscore (A₄)}

C₄=(B₁−\overline{B₁})/{double overscore (B₁)}

C₅=(B₃−\overline{B₃})/{double overscore (B₃)}

C₆=(B₄−\overline{B₄})/{double overscore (B₄)}

Form SYN rate component:

$${E}_{1} = \frac{{( Max ( Y - F - 1 , 0 ) )}^{2}}{\sqrt{( {D}^{2} + 4 )} * Max ( P , 1 )}$$

\overline{E₁}=Avg(E₁ᵢ)

{double overscore (E₁)}=St.Dev.(E₁ᵢ) Over all non-threat sessions

C₇=0.2 *Abs((E₁−\overline{E₁})/{double overscore (E₁)})

Form mail SYN rate component:

$${E}_{2} = \frac{{( Max ( M - 1 , 0 ) )}^{3}}{( {D}^{2} + 4 ) * Max ( P , 1 )}$$

\overline{E₂}=Avg (E₂ᵢ)

{double overscore (E₂)}=St.Dev.(E₂ᵢ) Over all non-threat sessions

C₈=Max(((E₂−\overline{E₂})/{double overscore (E₂)})³/2400, 0)

Form SYN rate/packet size component:

\overline{K}=Avg(Kᵢ) Over all non-threat sessions

$${G}_{3} = \frac{{E}_{1}}{{\overline{E}}_{1}} * \frac{\overline{K}}{K}$$

if K>0; G₃=0 Otherwise

\overline{G₃}=Avg(G₃ᵢ)

{double overscore (G₃)}=St.Dev.(G₃ᵢ) Over all non-threat sessions

C₉=0.2*Abs((G₃−\overline{G₃})/{double overscore (G₃)})

Form SYN rate inverse time sigma component:

$$\begin{matrix}\begin{matrix}\begin{matrix}{E}_{4} = \frac{( ( Y + F ) > 5 )}{q} \\ {F}_{4} = \frac{( ( Y + F ) > 5 ) * ( Y - F )}{\sqrt{( {D}^{2} + 400 )}}\end{matrix} \\ {G}_{4} = \frac{( ( Y + F ) > 5 ) * \overline{K}}{K}\end{matrix} \\ {H}_{4} = \frac{( ( Y + F ) > 5 ) * D}{\sqrt{( {D}^{2} + 100 )}}\end{matrix}$$

\overline{E₄}=Avg(E₄ᵢ)

\overline{F₄}=Avg(F₄ᵢ) Over all non-threat sessions

$${I}_{4} = \frac{{E}_{4}}{{\overline{E}}_{4}} * \frac{{F}_{4}}{{\overline{F}}_{4}} * {G}_{4} * {H}_{4}$$

if Y+F>5 (zero otherwise)

\overline{I₄}=Avg(I₄ᵢ)

{double overscore (I₄)}=St.Dev.(I₄ᵢ) Over all non-zero non-threat sessions

C₁₀=2 *ABS((I₄−\overline{I₄})/{double overscore (I₄)})*((Y+F)>5)

Compute handshake violation component:

$$HA = {[ \frac{NH * {( NH + 4 )}^{2}}{{( P + 10 )}^{3}} ]}^{3}$$

\overline{HA}=Avg(HAᵢ) over all HAᵢ>0

$${C}_{11} = \frac{1}{16} Abs ( \frac{HA}{\overline{HA}} )$$

Compute packet violation component:

C₁₂=PV (Most Recent>0)

Compute port change component:

$$PC = {[ \frac{( P - DP ) * ( P - DP - 3 )}{{( P + 10 )}^{2}} ]}^{4} * ( ( P - DP ) > 3 )$$

\overline{PC}=Avg(PCᵢ) overall PCᵢ>0

$${C}_{13} = 0.02 * \frac{PC}{\overline{PC}}$$

Compute ICMP rate component:

$$IC = {[ \frac{I * ( I + 4 )}{{( Abs ( P - 1.6 * I ) + 10 )}^{2}} ]}^{2}$$

$$IQ = \frac{IC}{0.002}$$

$${C}_{14} = \frac{IQ}{1 + 0.000001 * IQ}$$

Compute RST rate component:

$$RR = \frac{{R}^{8}}{{( P - R )}^{8} + {( P - 2 * R )}^{8} {10}^{8}}$$

$$RAV = Avg ( Ri ) Over all {R}_{i} > 0$$

$${C}_{15} = 0.04 * \frac{RR}{RAV}$$

Compute LSAR rate component:

$$TT = {[ \frac{L}{( P + 0.00001 )} ]}^{10}$$

$$TAV = Avg ( TT ) Over all TT > 0$$

$${C}_{16} = A bs ( \frac{TT}{TAV} )$$

Compute login failure component:

$${C}_{17} = {[ \frac{FL + 0.01}{2.65} ]}^{20}$$

Form final metric distance:

$$D = \sqrt{{\sum }_{i = 1}^{17} {C}_{i}^{2}}$$

Modifications

“Fire extinguisher” for SYN packet detector dimensions—one new input required

Time since second-to-last SYN packet recorded: R₃

$${E}_{5} = \frac{Max ( Y - 1 , 0 )}{\sqrt{( {D}^{2} + 4 )}}$$

$${C}_{i}^{′} = \frac{1.77853 * {C}_{i}}{\sqrt{1 + {( {R}_{3} * {E}_{5} )}^{2}}} , i = 7 \text{:} 10$$

Use Cᵢ instead of Cᵢ in equation for C.

Many-to-one

Handshake violation component—each client:

$$\begin{matrix}NHS = Σ ( P - DP ) & Over all sessions with same \\ & server and with NH > 0 \\ PS = Σ P & Over all sessions with same \\ & server and with NH > 0 \\ HA = {[ \frac{NHS * {( NHS + 4 )}^{2}}{{( PS + 10 )}^{3}} ]}^{3} & \\ \overline{HA} = Avg ( {HA}_{i} ) & over all {HA}_{i} > 0 \\ {S}_{1} = \frac{1}{16} A bs ( \frac{HA}{\overline{HA}} ) & \end{matrix}$$

Port change component—each client:

$$\begin{matrix}DPS = Σ ( P - DP ) & Over all sessions with same \\ & server and with P - DP > 3 \\ PC = {[ \frac{DPS * ( DPS - 3 )}{{( PS + 10 )}^{2}} ]}^{4} & \\ \overline{PC} = Avg ( {PC}_{i} ) & over all {PC}_{i} > 0 \\ {S}_{2} = 0.02 * \frac{PC}{\overline{PC}} & \end{matrix}$$

ICMP count component:

$$IC = {[ \frac{I * ( I + 4 )}{{( A b s ( P - 1.6 * I ) + 10 )}^{2}} ]}^{2}$$

$$IQ = \frac{IC}{0.002}$$

$${S}_{3} = \frac{IQ}{1 + 0.000001 * IQ}$$

$$Note \text{:} 0.002 rather than average over sessions$$

$$is used for normalization because there are so$$

$$few samples that could be used for normalization .$$

Form final metric distance:

$${D}^{′} = \sqrt{{\sum }_{i = 1}^{3} {CC}_{i}^{2}}$$

What is claimed is:

1. A method of deriving a threat metric that characterizes a threat potential for a specific session in a packet network, the method comprising:
accumulating historical data corresponding to at least some of a plurality of traffic parameters;
measuring the plurality of traffic parameters for the specific session;
producing a plurality of summary parameters characterizing the plurality of traffic parameters for the specific session;
producing, at least in part by scaling summary parameters using the historical data, a plurality of component metrics defining a point corresponding to the specific session in a multi-dimensional space containing a distribution of points corresponding to current sessions; and
determining a distance of the point from a centroid of the distribution to produce the threat metric.

2. The method of claim 1 wherein the plurality of traffic parameters comprises time between packets and inverse time between packets, and wherein the producing of the plurality of summary parameters further comprises computing central moments of the time between packets and the inverse time between packets.

3. The method of claim 1 wherein the producing of the plurality of summary parameters further comprises:
producing rates computed against numbers of packets; and
producing nonlinear generalizations of rates.

4. The method of claim 1 further comprising displaying the threat metric on a gram-metric display in connection with a network address associated with the specific session.

5. The method of claim 2 further comprising displaying the threat metric on a gram-metric display in connection with a network address associated with the specific session.

6. The method of claim 3 further comprising displaying the threat metric on a gram-metric display in connection with a network address associated with the specific session.

7. The method of claim 4 wherein the specific session comprises a plurality of subsessions associated with the network address, and wherein the producing of the plurality of summary parameters comprises summing a kernel over all of the plurality of subsessions.

8. The method of claim 5 wherein the specific session comprises a plurality of subsessions associated with the network address, and wherein the producing of the plurality of component metrics comprises summing a kernel over all of the plurality of subsessions.

9. The method of claim 6 wherein the specific session comprises a plurality of subsessions associated with the network address, and wherein the producing of the plurality of component metrics comprises summing a kernel over all of the plurality of subsessions.

10. The method of claim 1 wherein the plurality of traffic parameters comprises an indication of whether a packet violation exists, and the producing of the plurality of summary parameters comprises assigning a number to the packet violation.

11. The method of claim 2 wherein the plurality of traffic parameters further comprises an indication of whether a packet violation exists, and the producing of the plurality of summary parameters further comprises assigning a number to the packet violation.

12. A system for deriving a threat metric that characterizes a threat potential for a specific session in a packet network, the system comprising:
means for measuring a plurality of traffic parameters;
means for accumulating historical data corresponding to at least some of the plurality of traffic parameters;
means for producing a plurality of summary parameters characterizing the plurality of traffic parameters for the specific session;
means for producing a plurality of component metrics defining a point corresponding to the specific session in a multi-dimensional space containing a distribution of points corresponding to current sessions; and
means for determining a distance of the point from a centroid of the distribution to produce the threat metric.

13. The system of claim 12 further comprising means for displaying the threat metric on a gram-metric display in connection with a network address associated with the specific session.

14. A method of establishing and displaying a threat potential for each of a plurality of current sessions in a packet network, the method comprising:
accumulating historical data corresponding to at least some of a plurality of traffic parameters;
receiving, for each specific session of the plurality of current sessions, a plurality of summary parameters characterizing the plurality of traffic parameters for the specific session;
producing, at least in part by scaling summary parameters using the historical data, a plurality of component metrics defining a point for each specific session in a multi-dimensional space containing a distribution of points corresponding to the current sessions;
determining, for each specific session, a distance of the point for the specific session from a centroid of the distribution; and
displaying an indication of the distance for each specific session in connection with a network address associated with the specific session specific session as an indication of the threat potential.

15. The method of claim 14 wherein the plurality of component metrics comprises at least seven component metrics.

16. The method of claim 14 wherein at least one of the plurality of current sessions is a one-to-many session comprising a plurality of subsessions associated with the network address.

17. The method of claim 15 wherein at least one of the plurality of current sessions is a one-to-many session comprising a plurality of subsessions associated with the network address.

18. The method of claim 14 further comprising highlighting the indication if and when the distance for the specific session exceeds a pre-determined threshold.

19. The method of claim 15 further comprising highlighting the indication if and when the distance for the specific session exceeds a pre-determined threshold.

20. The method of claim 16 further comprising highlighting the indication if and when the distance for the specific session exceeds a pre-determined threshold.

21. The method of claim 14 further comprising highlighting the indication if and when the distance for the specific session is at least as great as a pre-determined threshold.

22. The method of claim 15 further comprising highlighting the indication if and when the distance for the specific session is at least as great as a pre-determined threshold.

23. The method of claim 16 further comprising highlighting the indication if and when the distance for the specific session is at least as great as a pre-determined threshold.

24. A computer program product including a computer program for enabling the display of a threat potential for each of a plurality of current sessions in a packet network, the computer program comprising:
instructions for accumulating historical data corresponding to at least some of a plurality of traffic parameters;
instructions for receiving, for each specific session of the plurality of current sessions, a plurality of summary parameters characterizing the plurality of traffic parameters for the specific session;
instructions for producing, at least in part by scaling summary parameters using the historical data, a plurality of component metrics defining a point for each specific session in a multi-dimensional space containing a distribution of points corresponding to the current sessions;
instructions for determining, for each specific session, a distance of the point for the specific session from a centroid of the distribution; and
instructions for displaying an indication of the distance for each specific session in connection with a network address associated with the specific session specific session as an indication of the threat potential.

25. The computer program product of claim 24 wherein the plurality of component metrics comprises at least seven component metrics.

26. The computer program product of claim 24 further comprising instructions for highlighting the indication if and when the distance for the specific session exceeds a pre-determined threshold.

27. The computer program product of claim 25 further comprising instructions for highlighting the indication if and when the distance for the specific session exceeds a pre-determined threshold.

28. The computer program product of claim 24 further comprising instructions for highlighting the indication if and when the distance for the specific session is at least as great as a pre-determined threshold.

29. The computer program product of claim 25 further comprising instructions for highlighting the indication if and when the distance for the specific session is at least as great as a pre-determined threshold.

30. An instruction execution system operable as an analysis station for displaying of a threat potential for each of a plurality of current sessions in a packet network, the instruction execution system comprising:
a network interface operable to receive, for each specific session of the plurality of current sessions, a plurality of summary parameters characterizing a plurality of traffic parameters for the specific session;
a processing system operatively connected to the network interface, the processing system operable to accumulate historical data corresponding to at least some of the plurality of traffic parameters, and to produce, at least in part by scaling summary parameters, a plurality of component metrics defining a point for each specific session in a multi-dimensional space containing a distribution of points corresponding to the current sessions, and to determine a distance of the point for the specific session from a centroid of the distribution; and
a display operably connected to the processing system, the display further being operable under the control of the processing system to display an indication of the distance for each specific session in connection with a network address associated with the specific session as an indication of the threat potential.

31. The system of claim 30 wherein the plurality of component metrics comprises at least seven component metrics.

32. The system of claim 30 wherein the display is further operable to highlight the indication if and when the distance for the specific session exceeds a predetermined threshold.

33. The system of claim 31 wherein the display is further operable to highlight the indication if and when the distance for the specific, session exceeds a predetermined threshold.

34. The system of claim 30 wherein the display is further operable to highlight the indication if and when the distance for the specific session is at least as great as a pre-determined threshold.

35. The system of claim 31 wherein the display is further operable to highlight the indication if and when the distance for the specific session is at least as great as a pre-determined threshold.

36. A method of monitoring traffic in a packet network to facilitate the characterization of a threat potential for each of a plurality of current sessions, the method comprising:
measuring a plurality of traffic parameters for each specific session in the plurality of current sessions;
producing a plurality of summary parameters characterizing the plurality of traffic parameters, the plurality of summary parameters being calculated to enable the determination of component metrics defining a point for each specific session in a multi-dimensional space containing a distribution of points corresponding to the current sessions, wherein a distance for the point from a centroid of the distribution characterizes the threat potential; and
sending the plurality of summary parameters to an analysis station over the packet network.

37. The method of claim 36 wherein the plurality of traffic parameters comprises time between packets and inverse time between packets, and wherein the producing of the plurality of summary parameters further comprises computing central moments of the time between packets and the inverse time between packets.

38. The method of claim 36 wherein the plurality of traffic parameters comprises an indication of whether a packet violation exists, and the producing of the plurality of summary parameters comprises assigning a number to the packet violation.

39. The method of claim 37 wherein the plurality of traffic parameters comprises an indication of whether a packet violation exists, and the producing of the plurality of summary parameters comprises assigning a number to the packet violation.

40. The method of claim 36 wherein the producing of the plurality of summary parameters further comprises producing rates computed against numbers of packets.

41. The method of claim 37 wherein the producing of the plurality of summary parameters further comprises producing rates computed against numbers of packets.

42. The method of claim 36 wherein the producing of the plurality of summary parameters further comprises producing nonlinear generalizations of rates.

43. The method of claim 37 wherein the producing of the plurality of summary parameters further comprises producing nonlinear generalizations of rates.

44. An instruction execution system operable as a monitoring agent for facilitating the characterization of a threat potential for each of a plurality of current sessions in a packet network, the instruction execution system comprising:
a first network interface operable to capture packets associated with the plurality of current sessions;
a processing system operatively connected to the first network interface, the processing system operable to control the instruction execution system to measure, based on captured packets, a plurality of traffic parameters for each specific session in the plurality of current sessions and to produce a plurality of summary parameters characterizing the plurality of traffic parameters, the plurality of summary parameters being calculated to enable the determination of component metrics defining a point for each specific session in a multi-dimensional space containing a distribution of points corresponding to the current sessions, wherein a distance for the point from a centroid of the distribution characterizes the threat potential; and
a second network interface operatively connected to the processing system operable to forward the plurality of summary parameters to an analysis station.

45. The system of claim 44 wherein the plurality of traffic parameters comprises time between packets and inverse time between packets, and wherein the producing of the plurality of summary parameters further comprises computing central moments of the time between packets and the inverse time between packets.

46. The system of claim 44 wherein the plurality of traffic parameters comprises an indication of whether a packet violation exists, and the producing of the plurality of summary parameters comprises assigning a number to the packet violation.

47. The system of claim 45 wherein the plurality of traffic parameters comprises an indication of whether a packet violation exists, and the producing of the plurality of summary parameters comprises assigning a number to the packet violation.

48. The system of claim 44 wherein the producing of the plurality of summary parameters further comprises producing rates computed against numbers of packets.

49. The system of claim 45 wherein the producing of the plurality of summary parameters further comprises producing rates computed against numbers of packets.

50. The system of claim 44 wherein the producing of the plurality of summary parameters further comprises producing nonlinear generalizations of rates.

51. The system of claim 45 wherein the producing of the plurality of summary parameters further comprises producing nonlinear generalizations of rates.

52. A computer program product including a monitoring agent program for monitoring traffic in a packet network to facilitate the characterization of a threat potential for each of a plurality of current sessions, the monitoring agent program comprising:
instructions for measuring a plurality of traffic parameters for each specific session in the plurality of current sessions;
instructions for producing a plurality of summary parameters characterizing the plurality of traffic parameters, the plurality of summary parameters being calculated to enable the determination of component metrics defining a point for each specific session in a multi-dimensional space containing a distribution of points corresponding to the current sessions; and
instructions for sending the plurality of summary parameters to an analysis station over the packet network.

53. The computer program product of claim 52, further including an analysis station program for enabling the determination and display of the threat potential for each of the plurality of current sessions in a packet network, the analysis station program comprising:
instructions for accumulating historical data;
instructions for receiving the plurality of summary parameters;
instructions for producing the component metrics, at least in part by scaling summary parameters using the historical data;
instructions for determining, for each specific session, a distance of the point for the specific session from a centroid of the distribution; and
instructions for displaying an indication of the distance for each specific session in connection with a network address associated with the specific session as an indication of the threat potential.

54. The computer program product of claim 52 wherein the plurality of traffic parameters comprises time between packets and inverse time between packets, and wherein the instructions for producing of the plurality of summary parameters further comprise instructions for computing central moments of the time between packets and the inverse time between packets.

55. The computer program product of claim 53 wherein the plurality of traffic parameters comprises time between packets and inverse time between packets, and wherein the instructions for producing of the plurality of summary parameters further comprise instructions for computing central moments of the time between packets and the inverse time between packets.

56. The computer program product of claim 52 wherein the plurality of traffic parameters comprises an indication of whether a packet violation exists, and the instructions for producing of the plurality of component metrics further comprise instructions for assigning a number to the packet violation.

57. The computer program product of claim 53 wherein the plurality of traffic parameters comprises an indication of whether a packet violation exists, and the instructions for producing of the plurality of component metrics further comprise instructions for assigning a number to the packet violation.

58. The computer program product of claim 52 wherein the instructions for producing of the plurality of component metrics further comprise instructions for producing rates computed against numbers of packets.

59. The computer program product of claim 52 wherein the instructions for producing of the plurality of component metrics further comprise instructions for producing nonlinear generalizations of rates.

60. The computer program product of claim 53 wherein the instructions for producing of the plurality of component metrics further comprise instructions for producing rates computed against numbers of packets.

61. The computer program product of claim 53 wherein the instructions for producing of the plurality of component metrics further comprise instructions for producing nonlinear generalizations of rates.

62. The computer program product of claim 53 wherein the instructions for producing the plurality of component metrics further comprise instructions for producing the plurality of component metrics for any of the plurality of current sessions which is a supersession comprising a plurality of subsessions associated with a network address.

63. The computer program product of claim 55 wherein the instructions for producing the plurality of component metrics further comprise instructions for producing the plurality of component metrics for any of the plurality of current sessions which is a supersession comprising a plurality of subsessions associated with a network address.

64. The computer program product of claim 57 wherein the instructions for producing the plurality of component metrics further comprise instructions for producing the plurality of component metrics for any of the plurality of current sessions which is a supersession comprising a plurality of subsessions associated with a network address.

65. The computer program product of claim 60 wherein the instructions for producing the plurality of component metrics further comprise instructions for producing the plurality of component metrics for any of the plurality of current sessions which is a supersession comprising a plurality of subsessions associated with a network address.

66. The computer program product of claim 61 wherein the instructions for producing the plurality of component metrics further comprise instructions for producing the plurality of component metrics for any of the plurality of current sessions which is a supersession comprising a plurality of subsessions associated with a network address.

67. The computer program product of claim 52 wherein the plurality of traffic parameters comprises an indication of whether a packet violation exists, and the instructions for producing of the plurality of component metrics further comprise instructions for assigning a number to the packet violation.

68. The computer program product of claim 53 wherein the plurality of traffic parameters comprises an indication of whether a packet violation exists, and the instructions for producing of the plurality of component metrics further comprise instructions for assigning a number to the packet violation.

69. The computer program product of claim 53 wherein the component metrics comprise at least seven component metrics.

70. The computer program product of claim 69 wherein the instructions for producing the plurality of component metrics further comprise instructions for producing the plurality of component metrics for any of the plurality of current sessions which is a supersession comprising a plurality of subsessions associated with a network address.
